(19) United States
(12) Patent Application Publication
(10) Pub. No.: US 2025/0317817 A1
(43) Pub. Date: Oct. 9, 2025

(54) METHOD AND APPARATUS FOR SUPPORTING L1/L2 SIGNALING BASED INTER-BASE STATION MOBILITY IN A WIRELESS COMMUNICATION SYSTEM

(71) Applicant: SAMSUNG ELECTRONICS CO., LTD., Suwon-si (KR)

(72) Inventors: Beomsik BAE, Suwon-si (KR); Weiping SUN, Suwon-si (KR); Jinwoo OCK, Suwon-si (KR); Seungri JIN, Suwon-si (KR); June HWANG, Suwon-si (KR)

(21) Appl. No.: 19/098,871

(22) Filed: Apr. 2, 2025

(30) Foreign Application Priority Data
Apr. 4, 2024 (KR) 10-2024-0045994
Nov. 7, 2024 (KR) 10-2024-0156728

(51) Int. Cl. H04W 36/04; H04W 36/08

(52) U.S. Cl. CPC H04W 36/04; H04W 36/08

(57) ABSTRACT

The disclosure relates to a 5G or 6G communication system for supporting a higher data transmission rate. A method for processing control signals in a wireless communication system according to the disclosure may include: receiving a first control signal transmitted from a base station; processing the received first control signal; and transmitting a second control signal generated based on the processing to the base station.

### CROSS-REFERENCE TO RELATED APPLICATIONS

This application is based on and claims priority under 35 U.S.C. § 119 to Korean Patent Application No. 10-2024-0045994 filed on Apr. 4, 2024, and Korean Patent Application No. 10-2024-0156728 filed on Nov. 7, 2024, in the Korean Intellectual Property Office, the disclosures of which are herein incorporated by reference in their entirety.

### BACKGROUND

### 1. Field

The disclosure relates to a wireless communication system or a mobile communication system. More specifically, the disclosure relates to a method and an apparatus for supporting layer 1/layer 2 (L1/L2) signaling-based inter-base station mobility in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure provides a method for reducing signaling overhead between base stations and between a base station and a UE such that, when a UE performs a layer 1/layer 2 signaling-based handover (L1/L2 triggered mobility (LTM)) in a mobile communication system, another layer 1/layer 2 signaling-based handover is supported after the UE completes an inter-base station handover. To this end, it is guaranteed that, during a configuration procedure for supporting a layer 1/layer 2 signaling-based handover, a continuous inter-base station handover based on layer 1/layer 2 signaling can be performed. To this end, the disclosure provides a method for transferring UE-related signals between the current serving base station and a new handover target base station, and a method for configuring security for ciphering and integrity protection in the new target base station.

The technical subjects pursued in the disclosure may not be limited to the above-mentioned technical subjects, and other technical subjects which are not mentioned may be clearly understood from the following descriptions by those skilled in the art to which the disclosure pertains.

In order to solve the above-mentioned problems, a method for processing control signals in a wireless communication system according to an embodiment includes: receiving a first control signal transmitted from a base station; processing the received first control signal; generating a second signal, based on the processing; and transmitting the generated second control signal to the base station.

According to embodiments provided in the disclosure, the UE is enabled to perform an operation for reducing signaling overhead between base stations and between a base station and the UE, which is for supporting another layer 1/layer 2 signaling-based handover, after completing an inter-base station handover.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of the structure of a mobile communication system according to an embodiment of the disclosure;

FIG. 2A illustrates a flowchart of a UE for performing a continuous inter-base station handover based on layer 1/layer 2 signaling according to an embodiment of the disclosure performs;

FIG. 2B illustrates a flowchart of a UE for performing a continuous inter-base station handover based on layer 1/layer 2 signaling according to an embodiment of the disclosure performs;

FIG. 3A illustrates a flowchart of a process for releasing all or part of a configuration for a continuous inter-base station handover based on layer 1/layer 2 signaling according to an embodiment of the disclosure;

FIG. 3B illustrates a flowchart of a process for releasing all or part of a configuration for a continuous inter-base station handover based on layer 1/layer 2 signaling according to an embodiment of the disclosure;

FIG. 3C illustrates a flowchart of a process for releasing all or part of a configuration for a continuous inter-base station handover based on layer 1/layer 2 signaling according to an embodiment of the disclosure;

FIG. 4A illustrates a signal flowchart of a UE process for performing a continuous inter-base station handover based on layer 1/layer 2 signaling according to an embodiment of the disclosure;

FIG. 4B illustrates a signal flowchart of a UE process for performing a continuous inter-base station handover based on layer 1/layer 2 signaling according to an embodiment of the disclosure;

FIG. 5 illustrates a flowchart of a UE process for performing releases configurations for a continuous inter-base station handover based on layer 1/layer 2 signaling according to an embodiment of the disclosure;

FIG. 6 illustrates a method of a UE for changing serving cells or performing an inter-base station handover where the UE and base stations generate a security key for ciphering and integrity protection according to an embodiment of the disclosure;

FIG. 7A illustrates a flowchart of a UE for performing a continuous inter-base station handover based on layer 1/layer 2 signaling by using an AS security key generating method according to an embodiment of the disclosure;

FIG. 7B illustrates a flowchart of a UE for performing a continuous inter-base station handover based on layer 1/layer 2 signaling by using an AS security key generating method according to an embodiment of the disclosure;

FIG. 7C illustrates a flowchart of a UE for performing a continuous inter-base station handover based on layer 1/layer 2 signaling by using an AS security key generating method according to an embodiment of the disclosure;

FIG. 8 illustrates a flowchart of a UE for performing a continuous inter-base station handover based on layer 1/layer 2 signaling by using an AS security key generating method according to an embodiment of the disclosure;

FIG. 9A illustrates a signal flowchart between a gNB-CU and a gNB-DU where a gNB is divided into a gNB-CU and a gNB-DU according to an embodiment of the disclosure;

FIG. 9B illustrates a signal flowchart between a gNB-CU and a gNB-DU where a gNB is divided into a gNB-CU and a gNB-DU according to an embodiment of the disclosure;

FIG. 10 illustrates a method between a UE and a base station for generating a security key for ciphering and integrity protection according to an embodiment of the disclosure;

FIG. 11A illustrates a flowchart of a UE for performing a continuous inter-base station handover based on layer 1/layer 2 signaling by using an AS security key generating method according to an embodiment of the disclosure;

FIG. 11B illustrates a flowchart of a UE for performing a continuous inter-base station handover based on layer 1/layer 2 signaling by using an AS security key generating method according to an embodiment of the disclosure;

FIG. 11C illustrates a flowchart of a UE for performing a continuous inter-base station handover based on layer 1/layer 2 signaling by using an AS security key generating method according to an embodiment of the disclosures;

FIG. 12 illustrates processes between a UE and a base station for generating a security key for ciphering and integrity protection when the UE performs a layer 1/layer 2 signaling-based handover according to an embodiment of the disclosure;

FIG. 13A illustrates a flowchart of a UE for performing a continuous inter-base station handover based on layer 1/layer 2 signaling by using an AS security key generating method according to an embodiment of the disclosure;

FIG. 13B illustrates a flowchart of a UE for performing a continuous inter-base station handover based on layer 1/layer 2 signaling by using an AS security key generating method according to an embodiment of the disclosure;

FIG. 13C illustrates a flowchart of a UE for performing a continuous inter-base station handover based on layer 1/layer 2 signaling by using an AS security key generating method according to an embodiment of the disclosures;

FIG. 14 illustrates a structure of an RAN node according to an embodiment of the disclosure; and

FIG. 15 illustrates a structure of a UE according to an embodiment of the disclosure.

### DETAILED DESCRIPTION

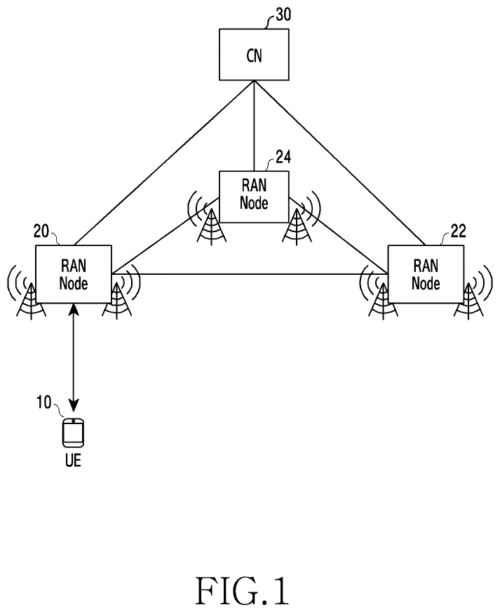

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the accompanying drawings, the same or like elements are designated by the same or like reference signs as much as possible. In describing the disclosure below, a detailed description of known functions or configurations incorporated herein will be omitted when it is determined that the description may make the subject matter of the disclosure unnecessarily unclear.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The present embodiments are provided only to completely disclose the disclosure and inform those skilled in the art of the scope of the disclosure, and the disclosure is defined only by the scope of the appended claims. Throughout the specification, the same or like reference signs indicate the same or like elements.

FIG. 1 illustrates an example of the structure of a mobile communication system according to an embodiment of the disclosure. RAN nodes 20, 22, and 24 illustrated in the structure of FIG. 1 may be mobile communication base stations connected to a core network (CN) 30 such as a 5G core network (5GC) or an evolved packet core network (EPC). The RAN nodes 20, 22, and 24 may be NR gNBs, LSTE eNBs, or the like, and the RAN nodes 20, 22, and 24 may be directly connected to each other. The user equipment (UE) 10 may communicate with the RAN node 20 of the cell in which the UE 10 is positioned, thereby receiving a service. As the UE 10 moves, the UE 10 may be connected to a new RAN node 22 or 24 so as to communicate therewith and receive a service according to the UE's performance of transmitting/receiving signals with the base station. The RAN nodes 20, 22, and 24 may be integrated base stations or split base stations which are divided into a central unit (CU), a distributed unit (DU), and the like.

Signaling procedures, ciphering key generating procedures, and the like included in the disclosure are embodiments of cases in which NG-RAN nodes and 5G cores (5GC) are used in 5G systems, and functions of base stations and core networks may be used in other mobile communication systems such as 4G systems and 6G systems.

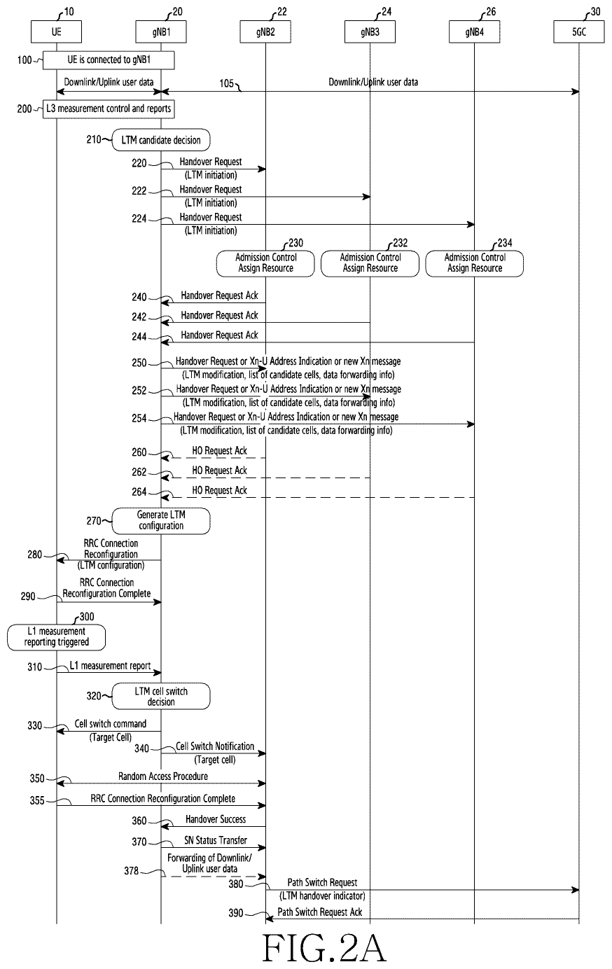

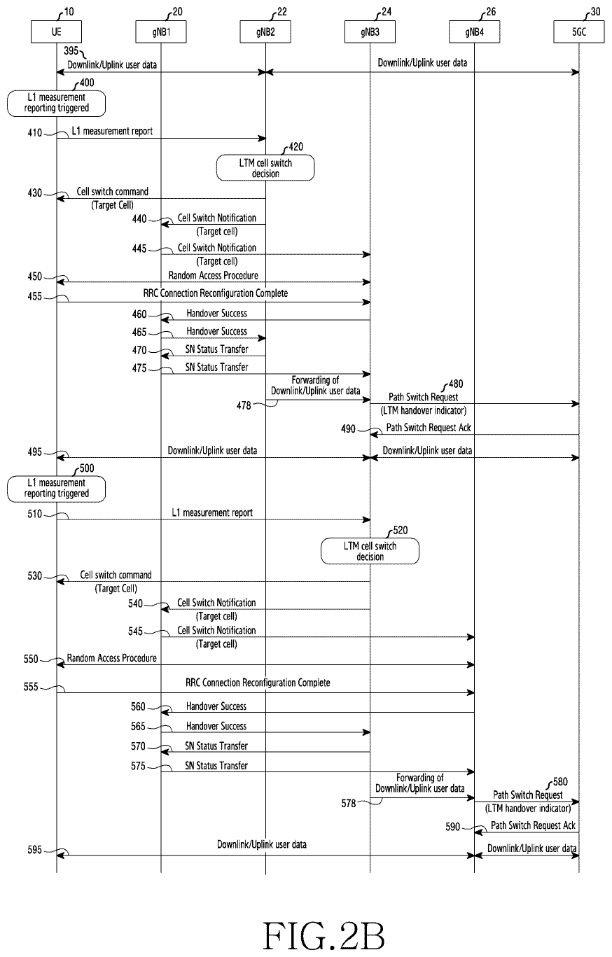

FIG. 2A and FIG. 2B illustrate flowcharts of a UE, according to an embodiment of the disclosure, for performing a continuous inter-base station handover based on layer 1/layer 2 signaling. In FIG. 2A and FIG. 2B, in connection with processes of transferring signal messages for the UE between base stations, signal messages for the UE may be transferred between base stations through a base station for which a continuous handover based on layer 1/layer 2 signaling is configured first.

Referring to FIG. 2A, the UE 10 may be connected to a gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200. Upon receiving the layer 3 measurement information from the UE 10 in step 200, the gNB 20 may determine whether or not to perform a configuration for performing a layer 1/layer 2 signaling-based handover for the UE 10 in step 210, may determine to perform a layer 1/layer 2 signaling-based handover, and may determine the target cell to which the UE may hand over and gNBs including the target cell.

The gNB1 20 may transmit handover request messages for configuring a layer 1/layer 2 signaling-based handover to gNBs determined in step 210, particularly to a gNB2 22, a gNB3 24, and a gNB4 26, respectively, in steps 220, 222, and 224. The handover request message may include information for LTM configurations and indicators such as L1/L2 triggered mobility (LTM) initiations indicating that a handover is to be configured based on layer 1/layer 2 signaling. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 in step 240, 242, and 244, respectively.

Upon receiving acknowledge messages from all gNBs to which handover request messages have been transmitted, the gNB1 20 may transmit messages including information regarding candidate cells to which the UE may move, information regarding candidate gNBs, and information regarding data forwarding in respective base stations, which is to be used for inter-base station data forwarding during the UE's handover, to the gNB2 22, the gNB3 24, and the gNB4 26 in steps 250, 252, and 254, respectively. The messages transmitted by the gNB1 20 in steps 250, 252, and 254 may include indicators such as LTM modification in handover request messages, or Xn-U address indication messages or new messages may be defined and used. In case that handover request messages are used in steps 250, 252, and 254, the gNB2 22, the gNB3 24, and the gNB4 26 may transmit handover request acknowledge messages to the gNB1 20 in step 260, 262, and 264, respectively.

The gNB1 20 may generate layer 1/layer 2 signaling-based handover configuration information (LTM configuration) to be transmitted to the UE, based on handover request acknowledge messages received from the gNB2 22, the gNB3 24, and the gNB4 26, in step 270. In addition, the gNB1 20 may transmit layer 1/layer 2 signaling-based handover configuration information to the UE 10 by using an RRC message (for example, RRCConnectionReconfiguration message) in step 280. The UE 10 may transmit an RRC message (for example, RRCConnectionReconfigurationComplete) to the gNB1 20 as a response in step 290.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 300, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. In addition, upon determining to instruct a handover, the gNB1 20 may transmit a cell switch command message by using a MAC CE in step 330, and the cell switch command message may include information regarding the target cell to which the UE 10 is to hand over. Upon determining whether or not to instruct the UE 10 to perform a layer 1/layer 2 signaling-based handover in step 320, the gNB1 20 may transmit a cell switch notification message to the gNB2 22 that is servicing the target cell to which the UE is to hand over in step 340, and the cell switch notification message may include information regarding the target cell to which the UE is to hand over, and other information regarding layer 1/layer 2 signaling-based handovers.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) to the gNB2 22 in step 355. Upon receiving the RRC message (for example, RRCConnectionReconfigurationComplete) from the UE 10, the gNB2 22 may transmit a handover success message to the gNB1 20 to inform that the UE 10 has completed the layer 1/layer 2 signaling-based handover to the gNB2 22 in step 360. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 transmits a path switch request message to the 5GC 30 to inform that the UE 10 has handed over to the gNB2 22 in step 380. The 5GC 30 transmit a path switch request acknowledge message to the gNB2 22 as a response in step 390. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

Referring to FIG. 2B, in case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 400, the UE 10 may transmit a layer 1 measurement report message to the gNB2 22 by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the measurement report information received from the UE 10, in step 420. Upon determining to instruct a handover, the gNB2 22 may transmit a cell switch command message by using a MAC CE in step 430. The cell switch command message may include information regarding the target cell to which the UE 10 is to hand over. Upon determining whether or not to instruct the UE 10 to perform a layer 1/layer 2 signaling-based handover in step 420, the gNB2 22 may transmit a cell switch notification message to the gNB3 24 that is servicing the target cell to which the UE 10 is to hand over. To this end, the gNB2 22 may transmit a cell switch notification message to the gNB1 20 in step 440, and the gNB1 20 may transmit the cell switch notification message to the gNB3 24 in step 445. The cell switch notification message may include information regarding the target cell to which the UE is to hand over, and other information regarding layer 1/layer 2 signaling-based handovers. Therefore, the gNB1 20 determines the gNB to which the cell switch notification message is to be transmitted from the gNB1 20, based on the target cell information included in the cell switch notification message.

Upon being instructed to perform a layer 1/layer 2 signaling-based handover in step 430, the UE 10 perform a procedure of random access to the target cell in step 450. Upon succeeding in the random access, the UE 10 may transmit an RRC message (for example, RRCConnectionReconfigurationComplete) to the gNB3 24 in step 455. Upon receiving the RRC message (for example, RRCConnectionReconfigurationComplete) from the UE 10, the gNB3 24 may transmit a handover success message to the gNB1 20 in step 460. The gNB1 20 may again transmit the handover success message to the gNB2 22 in step 465 to inform that the UE 10 has completed the layer 1/layer 2 signaling-based handover from the gNB2 22 to the gNB3 24. In case that data forwarding from the gNB2 22 to the gNB3 24 is necessary, the gNB2 22 may transmit an SN status transfer message including PDCP sequence information which is necessary for data forwarding and the like to the gNB1 20 in step 470. The gNB1 20 may transmit the SN status transfer message to the gNB3 24 in step 475. The gNB2 22 may forward data to the gNB3 24 in step 478.

The gNB3 24 may transmit a path switch request message to the 5GC 30 to inform that the UE 10 has handed over to the gNB3 24 in step 480. The 5GC 30 may transmit a path switch request acknowledge message to the gNB3 24 as a response in step 490. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

In case that the UE 10 completes the handover procedure by performing the procedure in steps 480 and 490, the UE 10 may be connected to the gNB3 24 (base station) so as to transmit/receive user packets through the gNB3 24 and 5GC 30 as in step 495.

In step 500, the UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 500, the UE 10 may transmit a layer 1 measurement report message to the gNB3 24 by using a medium access control (MAC) control element (CE) in step 510. In steps 500 and 510, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the measurement report information received from the UE 10, in step 520. Upon determining to instruct a handover, the gNB3 24 may transmit a cell switch command message by using a MAC CE in step 530. The cell switch command message may include information regarding the target cell to which the UE 10 is to hand over. Upon determining whether or not to instruct the UE 10 to perform a layer 1/layer 2 signaling-based handover in step 520, the gNB3 24 may transmit a cell switch notification message to the gNB4 26 that is servicing the target cell to which the UE is to hand over. To this end, the gNB3 24 may transmit a cell switch notification message to the gNB1 20 in step 540, and the gNB1 20 may transmit the cell switch notification message to the gNB4 26 in step 545. The cell switch notification message may include information regarding the target cell to which the UE is to hand over, and other information regarding layer 1/layer 2 signaling-based handovers. Therefore, the gNB1 20 may determine the gNB to which the cell switch notification message is to be transmitted from the gNB1 20, based on the target cell information included in the cell switch notification message.

Upon being instructed to perform a layer 1/layer 2 signaling-based handover in step 530, the UE 10 may perform a procedure of random access to the target cell in step 550. Upon succeeding in the random access, the UE 10 may transmit an RRC message (for example, RRCConnectionReconfigurationComplete) to the gNB4 26 in step 555. Upon receiving the RRC message (for example, RRCConnectionReconfigurationComplete) from the UE 10, the gNB4 26 may transmit a handover success message to the gNB1 20 in step 560. The gNB1 20 may again transmit the handover success message to the gNB3 24 in step 565 to inform that the UE 10 has completed the layer 1/layer 2 signaling-based handover from the gNB3 24 to the gNB4 26. In case that data forwarding from the gNB3 24 to the gNB4 26 is necessary, the gNB3 24 may transmit an SN status transfer message including PDCP sequence information which is necessary for data forwarding and the like to the gNB1 20 in step 570. The gNB1 20 may transmit the SN status transfer message to the gNB4 26 in step 575. The gNB3 24 may forward data to the gNB4 26 in step 578.

The gNB4 26 may transmit a path switch request message to the 5GC 30 to inform that the UE 10 has handed over to the gNB4 26 in step 580. The 5GC 30 may transmit a path switch request acknowledge message to the gNB4 26 as a response in step 590. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

In case that the UE 10 completes the handover procedure by performing the procedure in steps 580 and 590, the UE 10 may be connected to the gNB4 26 (base station) so as to transmit/receive user packets through the gNB4 26 and 5GC 30 as in step 595.

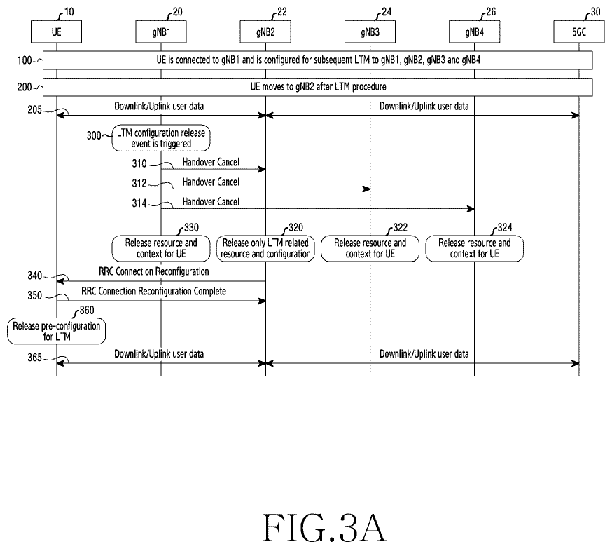

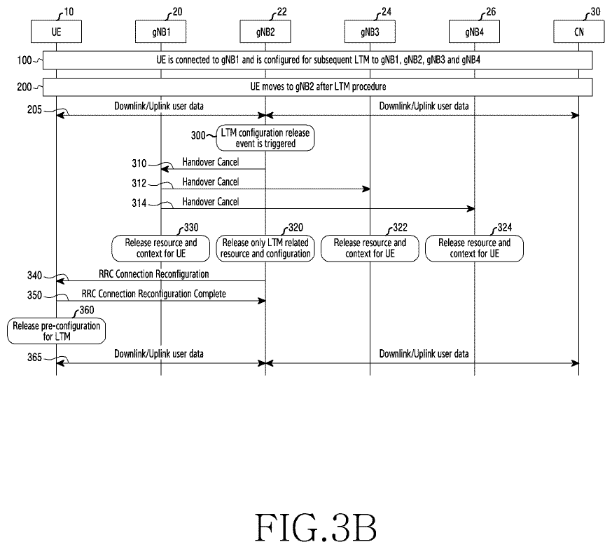

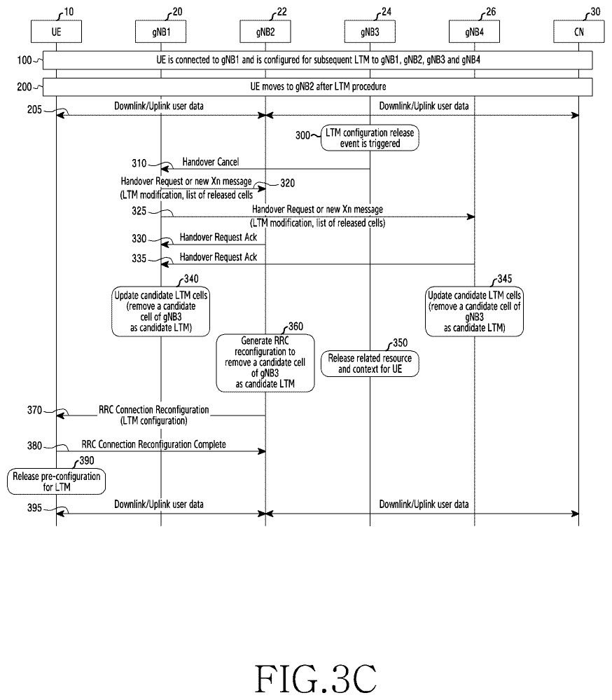

FIG. 3A, FIG. 3B, and FIG. 3C illustrate flowcharts of a process for releasing all or part of a configuration for a continuous inter-base station handover based on layer 1/layer 2 signaling according to an embodiment of the disclosure.

In connection with processes of transferring signal messages for the UE between base stations in FIG. 3A, FIG. 3B, and FIG. 3C, signal messages for the UE may be transferred between base stations through a base station for which a continuous handover based on layer 1/layer 2 signaling is configured first.

FIG. 3A illustrates a signal flowchart wherein the gNB1 20 which is the base station that has configured a continuous inter-base station handover based on layer 1/layer 2 signaling determines to release the configuration of the continuous inter-base station handover based on layer 1/layer 2 signaling, thereby releasing the configuration of the continuous inter-base station handover based on layer 1/layer 2 signaling.

Referring to FIG. 3A, the UE 10 may be connected to the gNB1 20 (base station) such that the gNB1 20 interworks with the gNB2 22, the gNB3 24, and the gNB4 26, thereby configuring a layer 1/layer 2 signaling-based handover, in step 100. The UE 10 may complete the procedure of layer 1/layer 2 signaling-based handover from the gNB1 20 to the gNB2 22, based on the layer 1/layer 2 signaling-based handover information configured in step 100, in step 200. The UE 10 may be connected to the gNB2 22 (base station) so as to transmit/receive user packets through the gNB2 22 and 5GC 30 in step 205.

In case that the gNB1 20 determines to release the layer 1/layer 2 signaling-based handover configuration which has been configured for the UE 10 because of internal policy, insufficient internal resources, or other reasons in step 300, the gNB1 20 may transmit handover cancel messages to the gNB2 22, the gNB3 24, and the gNB4 26 in steps 310, 312, and 314, respectively. Cause information may be newly defined and added to the handover cancel messages to indicate that the handover cancel messages are transmitted to release the layer 1/layer 2 signaling-based handover configuration.

After transmitting handover cancel messages to the gNB2 22, the gNB3 24, and the gNB4 26 in steps 310, 312, and 314, respectively, the gNB1 20 may release the resource of the gNB1 20, which has been allocated to service the UE 10, and context information of the UE 10 in step 330. After receiving the handover cancel messages from the gNB1 20 in steps 312 and 324, respectively, the gNB3 24 and gNB4 26 may release resources which have been allocated to service the UE 10, and context information of the UE 10, in step 322 and 324, respectively.

Upon receiving the handover cancel message from the gNB1 20 in step 310, the gNB2 22 may solely release the resource related to the layer 1/layer 2 signaling-based handover configured for the UE 10, and context information of the UE 10, in step 320. The gNB2 22 may transmit an RRC message (for example, RRCConnectionReconfiguration message) including information regarding release of the configuration regarding the layer 1/layer 2 signaling-based handover to the UE 10 in step 340. The UE 10 may transmit an RRC message (for example, RRCConnectionReconfigurationComplete) to the gNB2 22 in response to the RRCConnectionReconfiguration message, thereby updating RRC connection configuration information, in step 350. In addition, the UE 10 may be connected to the gNB2 22 (base station) so as to transmit/receive user packets through the gNB2 22 and 5GC 30 in step 365.

FIG. 3B illustrates a flowchart of a process for releasing a part of a configuration for a continuous inter-base station handover based on layer 1/layer 2 signaling, or the entire configuration, according to an embodiment of the disclosure. Specifically, FIG. 3B is a signal flowchart wherein the gNB2 22 (base station) to which the UE is currently connected determines to release the configuration of a continuous inter-base station handover based on layer 1/layer 2 signaling, thereby releasing the configuration of the continuous inter-base station handover based on layer 1/layer 2 signaling.

Referring to FIG. 3B, the UE 10 may be connected to the gNB1 20 (base station) such that the gNB1 20 interworks with the gNB2 22, the gNB3 24, and the gNB4 26, thereby configuring a layer 1/layer 2 signaling-based handover, in step 100. The UE 10 may complete the procedure of layer 1/layer 2 signaling-based handover from the gNB1 20 to the gNB2 22, based on the layer 1/layer 2 signaling-based handover information configured in step 100, in step 200. The UE 10 may be connected to the gNB2 22 (base station) so as to transmit/receive user packets through the gNB2 22 and 5GC 30 in step 205.

In case that the gNB2 22 determines to release the layer 1/layer 2 signaling-based handover configuration which has been configured for the UE 10 because of internal policy, insufficient internal resources, or other reasons in step 300, the gNB2 22 may transmit a handover cancel message to the gNB1 20 in step 310. Cause information may be newly defined and added to the handover cancel message to indicate that the handover cancel message is transmitted to release the layer 1/layer 2 signaling-based handover configuration.

Upon receiving the handover cancel message from the gNB2 22 in step 310, the gNB1 20 may transmit the handover cancel message to the gNB3 24 and gNB4 26 in steps 312 and 314, respectively.

In step 320, the resource that has been allocated to service the UE 10 and context information of the UE 10 may be released. In steps 312 and 314, the gNB3 24 and gNB4 26 may receive the handover cancel message from the gNB1 20, respectively. The gNB3 24 and gNB4 26 may release the resource that has been allocated to service the UE 10 and context information of the UE 10 in steps 322 and 324, respectively.

After transmitting the handover cancel message to the gNB1 20 in step 310, the gNB2 22 may solely release the resource related to the layer 1/layer 2 signaling-based handover configured for the UE 10, and context information of the UE 10, in step 330. In addition, the gNB2 22 may transmit an RRC message (for example, RRCConnectionReconfiguration message) including information regarding release of the configuration regarding the layer 1/layer 2 signaling-based handover to the UE 10 in step 340. The UE 10 may transmit an RRC message (for example, RRCConnectionReconfigurationComplete) to the gNB2 22 in step 350, thereby updating RRC connection configuration information. In addition, the UE 10 may be connected to the gNB2 22 (base station) so as to transmit/receive user packets through the gNB2 22 and 5GC 30 in step 365.

FIG. 3C illustrates a flowchart of a process for releasing a part of a configuration for a continuous inter-base station handover based on layer 1/layer 2 signaling, or the entire configuration, according to an embodiment of the disclosure.

Specifically, FIG. 3C illustrates a procedure for releasing only partial base station information configured for a continuous inter-base station handover based on layer 1/layer 2 signaling, and is a signal flowchart wherein the gNB3 20 determines to cancel the configuration of a continuous inter-base station handover based on layer 1/layer 2 signaling, thereby releasing the target cell of the gNB3 20 among candidates for which a continuous inter-base station handover based on layer 1/layer 2 signaling is configured.

Referring to FIG. 3C, the UE 10 may be connected to the gNB1 20 (base station) such that the gNB1 20 interworks with the gNB2 22, the gNB3 24, and the gNB4 26, thereby configuring a layer 1/layer 2 signaling-based handover, in step 100. The UE 10 may complete the procedure of layer 1/layer 2 signaling-based handover from the gNB1 20 to the gNB2 22, based on the layer 1/layer 2 signaling-based handover information configured in step 100, in step 200. The UE 10 may be connected to the gNB2 22 (base station) so as to transmit/receive user packets through the gNB2 22 and 5GC 30 in step 205.

In case that the gNB3 24 determines to release the layer 1/layer 2 signaling-based handover configuration which has been configured for the UE 10 because of internal policy, insufficient internal resources, or other reasons in step 300, the gNB3 24 may transmit a handover cancel message to the gNB1 20 in step 310. Information regarding the target cell for which the layer 1/layer 2 signaling-based handover is configured and cause information indicating that the handover cancel message is transmitted to release the layer 1/layer 2 signaling-based handover configuration may be newly defined and added to the handover cancel message. Upon receiving the handover cancel message from the gNB3 24 in step 310, the gNB1 20 may transmit a message including update information regarding candidate cells to which the UE may move to the gNB2 22 and gNB4 26 in step 320/325, respectively. The message transmitted by the gNB1 20 in step 320/325 may include an indicator such as LTM modification in a handover request message, or a new message may be defined and used. In case that a handover request message is used in step 320/325, the gNB2 22 and gNB4 26 may transmit a handover request acknowledge message to the gNB1 20 in step 330/335, respectively.

In steps 340 and 345, the gNB1 20 and gNB4 26 may update layer 1/layer 2 signaling-based handover configuration information for the UE 10, respectively, thereby releasing the target cell information to be released by the gNB3 24. The gNB2 22 to which the UE 10 is currently connected may update the layer 1/layer 2 signaling-based handover configuration information, thereby releasing the target cell information to be released by the gNB3 24, in step 360. In step 370, the gNB2 22 may transmit an RRC message (for example, RRCConnectionReconfiguration message) including layer 1/layer 2 signaling-based handover-related configuration update information to the UE 10. In step 380, the UE 10 may transmit an RRC message (for example, RRCConnectionReconfigurationComplete) to the gNB2 22 as a response. In step 390, the UE 10 may update the layer 1/layer 2 signaling-based handover-related configuration information. In addition, the UE 10 may be connected to the gNB2 22 (base station) so as to transmit/receive user packets through the gNB2 22 and 5GC 30 in step 395.

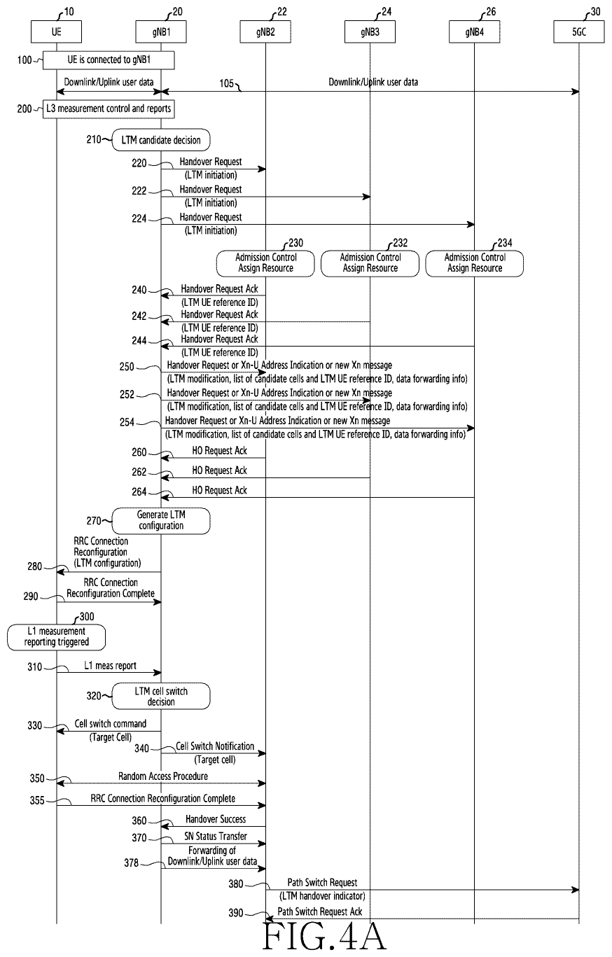

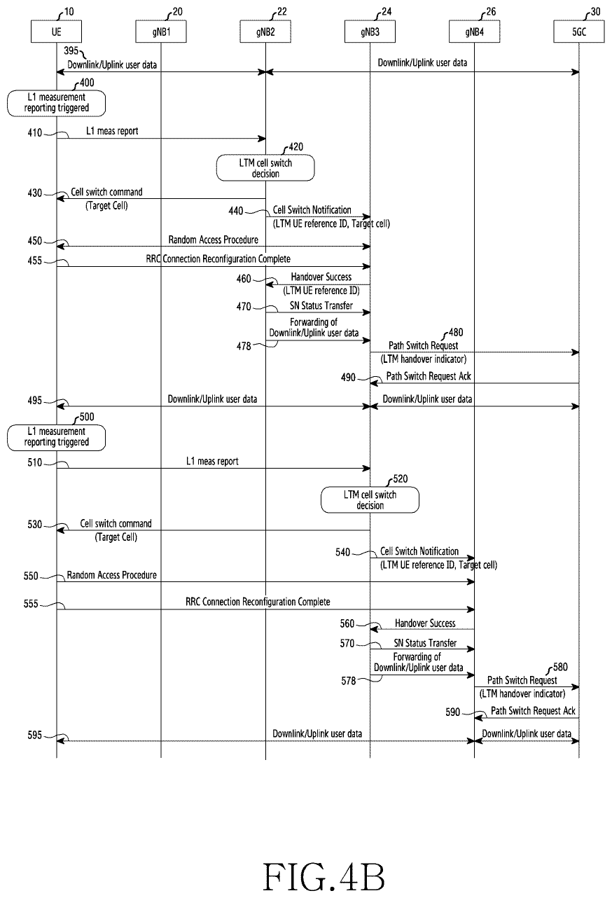

FIG. 4A and FIG. 4B illustrate signal flowcharts in connection with processes in which a UE according to an embodiment of the disclosure performs a continuous inter-base station handover based on layer 1/layer 2 signaling. In connection with processes of transferring signal messages for the UE between base stations in FIG. 4A and FIG. 4B, signal messages for the UE may be directly transferred between base stations having layer 1/layer 2 signaling-based continuous handover candidates configured therefor.

Referring to FIG. 4A, the UE 10 may be connected to gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200. Upon receiving the layer 3 measurement information from the UE 10 in step 200, the gNB 20 may determine whether or not to perform a configuration for performing a layer 1/layer 2 signaling-based handover for the UE 10 in step 210, may determine to perform a layer 1/layer 2 signaling-based handover, and may determine the target cell to which the UE may hand over and gNBs including the target cell.

The gNB1 20 may transmit handover request messages for configuring a layer 1/layer 2 signaling-based handover to gNBs determined in step 210, particularly to the gNB2 22, the gNB3 24, and the gNB4 26, respectively, in steps 220/222/224. The handover request message may include information for LTM configurations and indicators such as L1/L2 triggered mobility (LTM) initiations indicating that a handover is to be configured based on layer 1/layer 2 signaling. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 from the gNB2 22, the gNB3 24, and the gNB4 26 in step 240, 242, and 244, respectively. The handover request acknowledge messages may include identifier information to be used by a candidate cell or gNB to identify the UE for the sake of a layer 1/layer 2 signaling-based handover, for example, target NG-RAN node UE XnAP ID or LTM UE reference ID information.

Upon receiving acknowledge messages from all gNBs to which handover request messages have been transmitted, the gNB1 20 may transmit messages including information regarding candidate cells to which the UE may move, information regarding candidate gNBs, identifier information (LTM UE reference ID) to be used by candidate cells and gNBs to identify the UE 10, and information regarding data forwarding in respective base stations, which is to be used for inter-base station data forwarding during the UE's handover, to the gNB2 22, the gNB3 24, and the gNB4 26 in steps 250, 252, and 254, respectively. The identifier information for identifying the UE may be included in the handover request acknowledge messages received from respective base stations in steps 240, 242, and 244, and may the following information, which however is not limitative.
NG-RAN node UE XnAP ID (an identifier to be used by each base station to identify the UE in XnAP interface)
LTM UE Reference ID (a separate identifier to be used by each candidate/target cell to identify the UE)

The messages transmitted by the gNB1 20 in steps 250, 252, and 254 may include indicators such as LTM modification in handover request messages, or Xn-U address indication messages or new messages may be defined and used. In case that handover request messages are used in steps 250, 252, and 254, the gNB2 22, the gNB3 24, and the gNB4 26 may transmit handover request acknowledge messages to the gNB1 20 in step 260, 262, and 264, respectively.

The gNB1 20 may generate layer 1/layer 2 signaling-based handover configuration information (LTM configuration) to be transmitted to the UE, based on messages received from the gNB2 22, the gNB3 24, and the gNB4 26, in step 270. The gNB1 20 may transmit layer 1/layer 2 signaling-based handover configuration information to the UE 10 by using an RRC message (for example, RRCConnectionReconfiguration message) in step 280. Thereafter, the UE 10 may transmit an RRC message (for example, RRCConnectionReconfigurationComplete) to the gNB1 20 as a response to the RRCConnectionReconfiguration message in step 290.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 300, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. Upon determining to instruct a handover, the gNB1 20 may transmit a cell switch command message by using a MAC CE in step 330, and the cell switch command message may include information regarding the target cell to which the UE 10 is to hand over. Upon determining whether or not to instruct the UE 10 to perform a layer 1/layer 2 signaling-based handover in step 320, the gNB1 20 may transmit a cell switch notification message to the gNB2 22 that is servicing the target cell to which the UE is to hand over in step 340. The cell switch notification message may include identifier information for identifying the UE (NG-RAN node UE XnAP ID in a receiving gNB, or LTM UE reference ID), information regarding the target cell to which the UE is to hand over, and other information regarding layer 1/layer 2 signaling-based handovers.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) to the gNB2 22 in step 355. Upon receiving the RRC message (for example, RRCConnectionReconfigurationComplete) from the UE 10, the gNB2 22 may transmit a handover success message to the gNB1 20 to inform that the UE 10 has completed the layer 1/layer 2 signaling-based handover to the gNB2 22 in step 360. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 may transmit a path switch request message to the 5GC 30 to inform that the UE 10 has handed over to the gNB2 22 in step 380. The 5GC 30 may transmit a path switch request acknowledge message to the gNB2 22 as a response in step 390. The path switch request message may include an indicator such as an LTM handover indicator which indicates that the UE has performed a layer 1/layer 2 signaling-based handover. Upon receiving the LTM handover indicator, the 5GC 30 may perform necessary operations, such as configuring the UE's policy.

Referring to FIG. 4B, in case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 400, the UE 10 may transmit a layer 1 measurement report message to the gNB2 22 by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the measurement report information received from the UE 10, in step 420. Upon determining to instruct a handover, the gNB2 22 may transmit a cell switch command message by using a MAC CE in step 430. The cell switch command message may include information regarding the target cell to which the UE 10 is to hand over. Upon determining whether or not to instruct the UE 10 to perform a layer 1/layer 2 signaling-based handover in step 420, the gNB2 22 may transmit a cell switch notification message to the gNB3 24 that is servicing the target cell to which the UE is to hand over in step 440. The cell switch notification message may include identifier information for identifying the UE (NG-RAN node UE XnAP ID in a receiving gNB, or LTM UE reference ID), information regarding the target cell to which the UE is to hand over, and other information regarding layer 1/layer 2 signaling-based handovers. Upon being instructed to perform a layer 1/layer 2 signaling-based handover in step 430, the UE 10 perform a procedure of random access to the target cell in step 450. Upon succeeding in the random access, the UE 10 may transmit an RRC message (for example, RRCConnectionReconfigurationComplete) to the gNB3 24 in step 455. Upon receiving the RRC message (for example, RRCConnectionReconfigurationComplete) from the UE 10, the gNB3 24 may transmit a handover success message to the gNB2 22 in step 460, thereby informing that the UE 10 has completed the layer 1/layer 2 signaling-based handover from the gNB2 22 to the gNB3 24. The handover success message includes identifier information for identifying the UE (NG-RAN node UE XnAP ID in a receiving gNB, or LTM UE reference ID). In case that data forwarding from the gNB2 22 to the gNB3 24 is necessary, the gNB2 22 may transmit an SN status transfer message including PDCP sequence information which is necessary for data forwarding and the like to the gNB3 24 in step 470. The gNB2 22 may forward data to the gNB3 24 in step 478.

The gNB3 24 may transmit a path switch request message to the 5GC 30 to inform that the UE 10 has handed over to the gNB3 24 in step 480. The 5GC 30 may transmit a path switch request acknowledge message to the gNB3 24 as a response in step 490. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

In case that the UE 10 completes the handover procedure by performing the procedure in steps 480 and 490, the UE 10 may be connected to the gNB3 24 (base station) so as to transmit/receive user packets through the gNB3 24 and 5GC 30 as in step 495.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 500, the UE 10 may transmit a layer 1 measurement report message to the gNB3 24 by using a medium access control (MAC) control element (CE) in step 510. In steps 500 and 510, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the measurement report information received from the UE 10, in step 520. Upon determining to instruct a handover, the gNB3 24 may transmit a cell switch command message by using a MAC CE in step 530. The cell switch command message may include information regarding the target cell to which the UE 10 is to hand over. Upon determining whether or not to instruct the UE 10 to perform a layer 1/layer 2 signaling-based handover in step 520, the gNB3 24 may transmit a cell switch notification message to the gNB4 26 that is servicing the target cell to which the UE is to hand over in step 540. The cell switch notification message may include identifier information for identifying the UE (NG-RAN node UE XnAP ID in a receiving gNB, or LTM UE reference ID), information regarding the target cell to which the UE is to hand over, and other information regarding layer 1/layer 2 signaling-based handovers.

Upon being instructed to perform a layer 1/layer 2 signaling-based handover in step 530, the UE 10 may perform a procedure of random access to the target cell in step 550. Upon succeeding in the random access, the UE 10 may transmit an RRC message (for example, RRCConnectionReconfigurationComplete) to the gNB4 26 in step 555. Upon receiving the RRC message (for example, RRCConnectionReconfigurationComplete) from the UE 10, the gNB4 26 may transmit a handover success message to the gNB3 24 in step 560, thereby informing that the UE 10 has completed the layer 1/layer 2 signaling-based handover from the gNB3 24 to the gNB4 26. The handover success message includes identifier information for identifying the UE (NG-RAN node UE XnAP ID in a receiving gNB, or LTM UE reference ID). In case that data forwarding from the gNB3 24 to the gNB4 26 is necessary, the gNB3 24 may transmit an SN status transfer message including PDCP sequence information which is necessary for data forwarding and the like to the gNB4 26 in step 570. The gNB3 24 may forward data to the gNB4 26 in step 578.

The gNB4 26 may transmit a path switch request message to the 5GC 30 to inform that the UE 10 has handed over to the gNB4 26 in step 580. The 5GC 30 may transmit a path switch request acknowledge message to the gNB4 26 in response to the path switch request message in step 590. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

In case that the UE 10 completes the handover procedure by performing the procedure in steps 580 and 590, the UE 10 may be connected to the gNB4 26 (base station) so as to transmit/receive user packets through the gNB4 26 and 5GC 30 as in step 595.

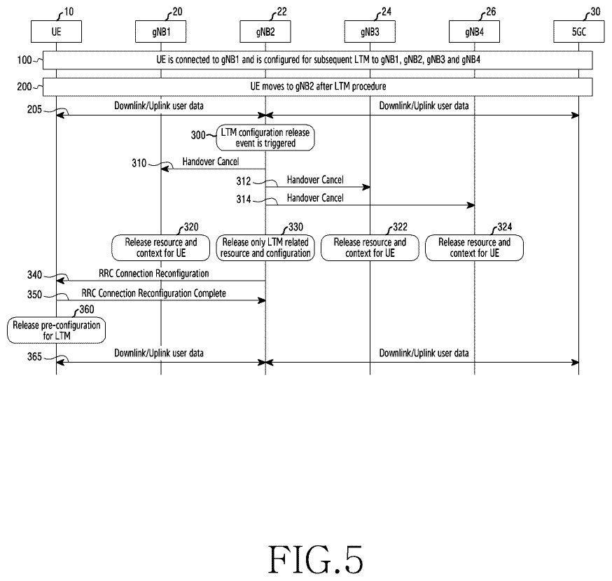

FIG. 5 illustrates a flowchart of a UE, according to an embodiment of the disclosure, for releasing configurations for a continuous inter-base station handover based on layer 1/layer 2 signaling.

Specifically, FIG. 5 illustrates a signal flowchart for halfway releasing configurations for a continuous inter-base station handover based on layer 1/layer 2 signaling in connection with processes in which a UE according to an embodiment of the disclosure performs a continuous inter-base station handover based on layer 1/layer 2 signaling. In connection with processes of transferring signal messages for the UE between base stations in FIG. 5, signal messages for the UE may be transferred between base stations through direct communication between base stations for which a continuous handover based on layer 1/layer 2 signaling is configured. FIG. 5 is a signal flowchart wherein the UE determines to release configurations for a continuous inter-base station handover based on layer 1/layer 2 signaling in the gNB2 22 (base station) to which the UE is currently connected, thereby releasing the configurations for a continuous inter-base station handover based on layer 1/layer 2 signaling.

Referring to FIG. 5, the UE 10 may be connected to the gNB1 20 (base station) such that the gNB1 20 interworks with the gNB2 22, the gNB3 24, and the gNB4 26, thereby configuring a layer 1/layer 2 signaling-based handover, in step 100. The UE 10 may complete the procedure of layer 1/layer 2 signaling-based handover from the gNB1 20 to the gNB2 22, based on the layer 1/layer 2 signaling-based handover information configured in step 100, in step 200. The UE 10 may be connected to the gNB2 22 (base station) so as to transmit/receive user packets through the gNB2 22 and 5GC 30 in step 205.

The gNB2 22 may determine to release the layer 1/layer 2 signaling-based handover configuration which has been configured for the UE 10 because of internal policy, insufficient internal resources, or other reasons in step 300. Accordingly, the gNB2 22 may transmit handover cancel messages to the gNB1 20, the gNB3 24, and the gNB4 26 in steps 310, 312, and 314, respectively. Cause information may be newly defined and added to the handover cancel messages to indicate that the handover cancel messages are transmitted to release the layer 1/layer 2 signaling-based handover configuration.

After receiving handover cancel messages from the gNB2 22 in step 310, the gNB1 20, the gNB3 24, and the gNB4 26 may release the resources which have been allocated to service the UE 10, and context information of the UE 10, in steps 320, 322, and 324, respectively.

After transmitting the handover cancel messages to the gNB1 20, the gNB3 24, and the gNB4 26 in steps 310, 312, and 314, respectively, the gNB2 22 may solely release the resource related to layer 1/layer 2 signaling-based handovers configured for the UE 10, and context information of the UE 10, in step 330. The gNB2 22 may transmit an RRC message (for example, RRCConnectionReconfiguration message) including information regarding release of the configuration regarding layer 1/layer 2 signaling-based handovers to the UE 10 in step 340. The UE 10 may transmit an RRC message (for example, RRCConnectionReconfigurationComplete) to the gNB2 22 as a response in step 350, and may update RRC connection configuration information in step 360. In addition, the UE 10 may be connected to the gNB2 22 (base station) so as to transmit/receive user packets through the gNB2 22 and 5GC 30 in step 365.

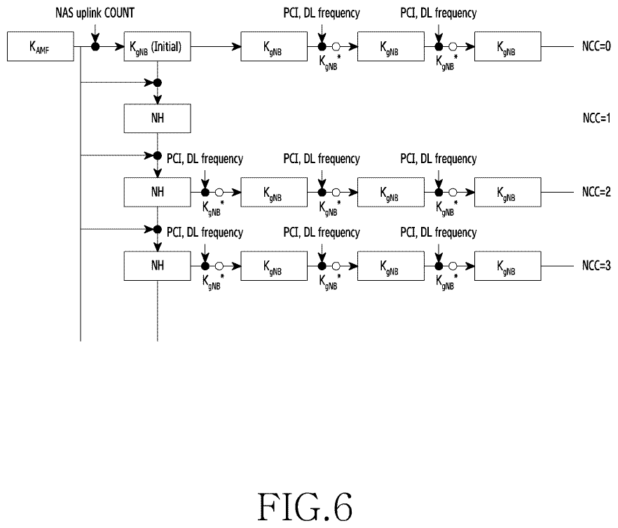

FIG. 6 illustrates a method wherein, in case that a UE according to an embodiment of the disclosure changes serving cells or performs an inter-base station handover, the UE and base stations generate a security key for ciphering and integrity protection.

In order for a UE and a gNB to generate initial access stratum (AS) security context, an access and mobility management function (AMF) included in a 5G core network (5GC) and the UE may generate a KgNB security key and a next hop (NH) security key, which are used for security, and the AMF may transfer the KgNB security key and NH key to the gNB. The KgNB security key and NH key may be generated based on a KAMF security key used between the AMF and the UE. In addition, the generated KgNB security key and NH key may be connected to a next hop chain count (NCC) value as a parameter and used accordingly. During the initial configuration, the KgNB is directly derived from the KAMF, and the NCC value is then associated with 0. The NH security key generated thereafter may be connected to NCC value of 1.

The UE and gNB use the KgNB for communication security with each other, and may generate a security key for performing ciphering and integrity protection, based on the KgNB. In case that the ULE hands over and switches from RRC_INACTIVE to RRC_CONNECTED state, for example, the AS security key to be used between the UE and target gNB is generated in the currently activated KgNB, and may be generated by using information such as a physical cell identifier (PCI) or downlink frequency (ARFCN-DL) used in the UE's serving cell or in the target cell during a handover. A case in which a new security key is generated in the currently activated KgNB may correspond to a process in which a horizontal key is generated. A case in which the NH security key is used for generation may correspond to a process in which a vertical key is generated.

The NH security key may be solely generated in the UE and AMF, and may be provided from the AMF to the gNB and used for AS security key generation.

In case that the UE performs an inter-gNB handover, the AMF generates a new NH security key and then transfers NCC information associated with the NH security key to the target gNB such that the target gNB generates a new AS security key.

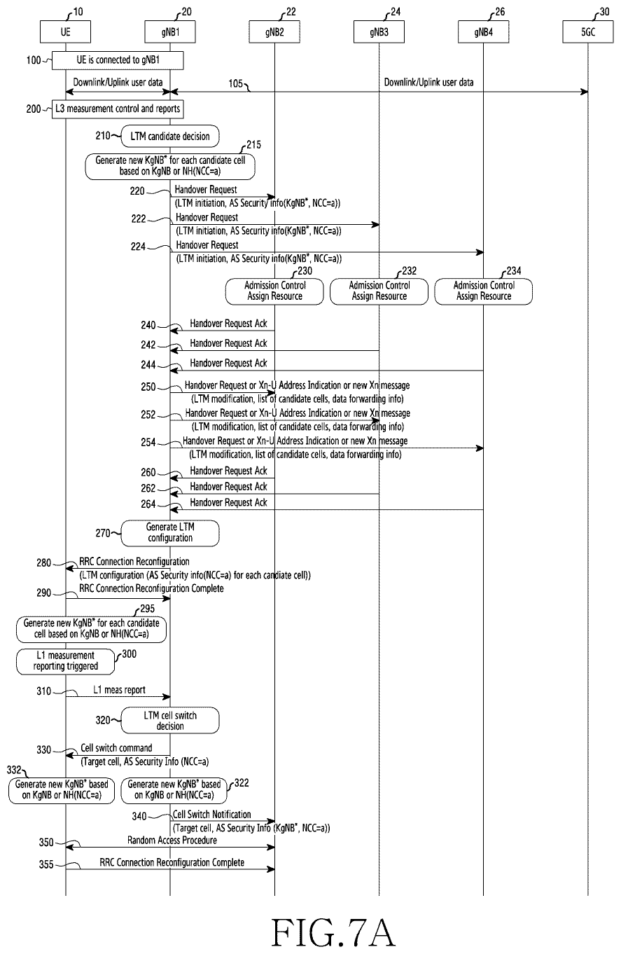

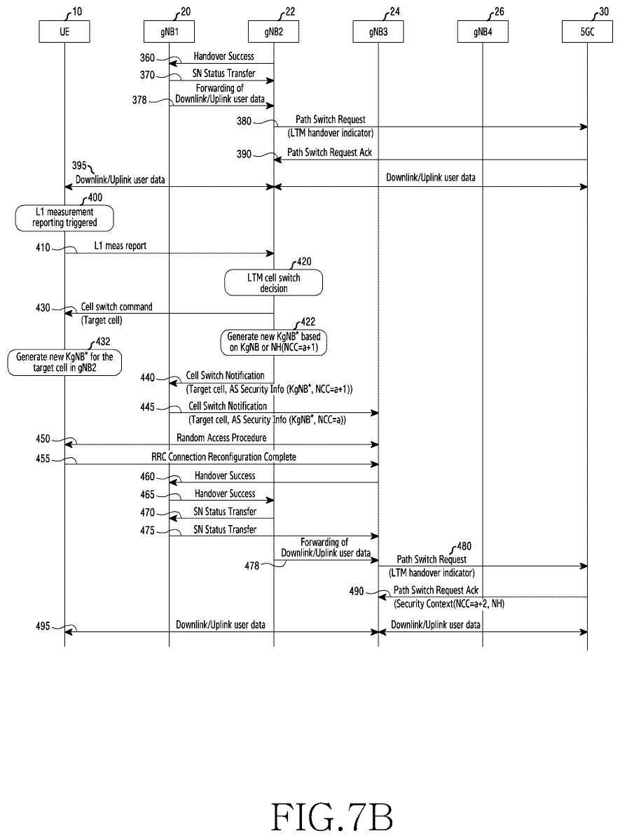

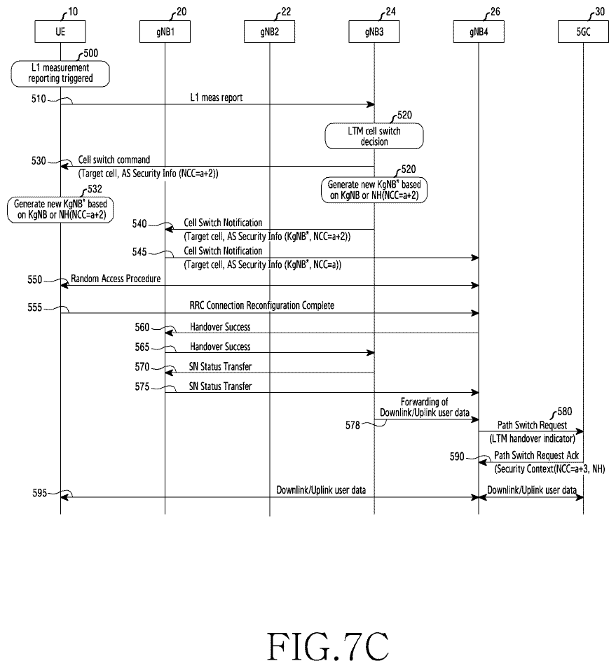

FIG. 7A, FIG. 7B, and FIG. 7C illustrates signal flowcharts wherein, in connection with processes in which a UE according to an embodiment of the disclosure performs a continuous inter-base station handover based on layer 1/layer 2 signaling, the UE operates by using an AS security key generating method as in FIG. 6. In connection with processes of transferring signal messages for the UE between base stations in FIG. 7A, FIG. 7B, and FIG. 7C, signal messages for the UE may be transferred between base stations through a base station for which a continuous inter-base station handover based on layer 1/layer 2 signaling is configured first.

Referring to FIG. 7A, the UE 10 may be connected to the gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200. Upon receiving the layer 3 measurement information from the UE 10 in step 200, the gNB 20 may determine whether or not to perform a configuration for performing a layer 1/layer 2 signaling-based handover for the UE 10 in step 210, and may determine to perform a layer 1/layer 2 signaling-based handover. In addition, the gNB 20 may determine the target cell to which the UE may hand over and gNBs including the target cell. In step 215, the gNB1 20 may generate a KgNB* security key which is to be used in each candidate cell to which the UE 10 may hand over, by using a KgNB security key which is currently used for security or an NH security key in case that there is an NH security key which has been received from the AMF and then stored therein. In connection with the KgNB* security key generated in step 215, each candidate cell's PCI and DL frequency information may differ, and a different KgNB* security key may accordingly be generated for each candidate cell.

The gNB1 20 transmits handover request messages for configuring a layer 1/layer 2 signaling-based handover to gNBs determined in step 210, particularly to the gNB2 22, the gNB3 24, and the gNB4 26, respectively, in steps 220, 222, and 224. The handover request message includes an indicator such as L1/L2 triggered mobility (LTM) initiation indicating that a handover is to be configured based on layer 1/layer 2 signaling, AS security information, information for LTM configurations, and the like. The AS security information may include NCC information associated with a KgNB* security key to be used for security in each candidate cell/candidate gNB. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 in step 240, 242, and 244, respectively.

Upon receiving acknowledge messages from all gNBs to which handover request messages have been transmitted, the gNB1 20 may transmit messages including information regarding candidate cells to which the UE may move, information regarding candidate gNBs, and information regarding data forwarding in respective base stations, which is to be used for inter-base station data forwarding during the UE's handover, to the gNB2 22, the gNB3 24, and the gNB4 26 in steps 250, 252, and 254, respectively. The messages transmitted by the gNB1 20 in steps 250, 252, and 254 may include indicators such as LTM modification in handover request messages, or Xn-U address indication messages or new messages may be defined and used. In case that handover request messages are used in steps 250, 252, and 254, the gNB2 22, the gNB3 24, and the gNB4 26 may transmit handover request acknowledge messages to the gNB1 20 in step 260, 262, and 264, respectively.

The gNB1 20 may generate layer 1/layer 2 signaling-based handover configuration information (LTM configuration) to be transmitted to the UE, based on acknowledge messages received from the gNB2 22, the gNB3 24, and the gNB4 26, respectively, in step 270. The gNB1 20 may transmit layer 1/layer 2 signaling-based handover configuration information to the UE 10 by using an RRC message (for example, RRCConnectionReconfiguration message) in step 280. The UE 10 may transmit an RRC message (for example, RRCConnectionReconfigurationComplete) to the gNB1 20 as a response in step 290. The RRC message (for example, RRCConnectionReconfiguration message) that the UE 10 has received from the gNB1 20 in step 280 may include each candidate cell-specific AS security information, and the AS security information may include NCC information which may indicate security key information to be used during a handover with regard to each candidate cell. In step 295, the UE 10 may use a KgNB security key associated with the NCC transferred with regard to each candidate cell, or may generate an NH security key and then generate a new KgNB* security key with regard to each candidate cell.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 300, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. Upon determining to instruct a handover, the gNB1 20 may transmit a cell switch command message by using a MAC CE in step 330. The cell switch command message may include information regarding the target cell to which the UE 10 is to hand over, and AS security information. The AS security information included in the cell switch command message may include NCC information which may indicate security key information to be used in the target cell to which the UE is to hand over. Instead of generating and storing the AS security key in step 295, the UE 10 may generate a KgNB security key associated with the NCC to be used in the target cell ins step 332, or may generate an NH security key and then generate a KgNB* security key in the target cell. In case that the cell switch command message received in step 330 includes no AS security information, and the UE 10 thus receives no NCC information for generating an AS security key in the target cell, the NCC value associated with the KgNB security key currently used in the serving cell may be increased by 1, and then used as the NCC value for generating an AS security key to be used in the target cell.

Upon determining whether or not to instruct the UE 10 to perform a layer 1/layer 2 signaling-based handover in step 320, the gNB1 20 may generate a KgNB* security key to be used in the target cell to which the UE 10 is to hand over, by using a KgNB security key which is currently used for security, or an NH security key in case that there is an NH security key received from the AMF and then stored, in step 322. In addition, a cell switch notification message may be transmitted to the gNB2 22 that is servicing the target cell to which the UE is to hand over in step 340, and the cell switch notification message may include information regarding the target cell to which the UE is to hand over, AS security information, and other information regarding layer 1/layer 2 signaling-based handovers. The AS security information included in the cell switch notification message may include NCC information associated with a KgNB* security key to be used for security in the target cell/target gNB.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) to the gNB2 22 in step 355.

FIG. 7B illustrates a flowchart of a UE for performing a continuous inter-base station handover based on layer 1/layer 2 signaling by using an AS security key generating method according to an embodiment of the disclosure. FIG. 7B illustrates operations which may be performed successively after the operations illustrated in FIG. 7A.

Referring to FIG. 7B, upon receiving an RRC message (for example, RRCConnectionReconfigurationComplete) from the UE 10, the gNB2 22 may transmit a handover success message to the gNB1 20 in step 360, thereby informing that the UE 10 has completed a layer 1/layer 2 signaling-based handover to the gNB2 22. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 transmits a path switch request message to the 5GC 30 to inform that the UE 10 has handed over to the gNB2 22 in step 380. The 5GC 30 may transmit a path switch request acknowledge message to the gNB2 22 as a response in step 390. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

The path switch request acknowledge message transmitted in step 390 may include security context information transmitted to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 400, the UE 10 may transmit a layer 1 measurement report message to the gNB2 22 by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the measurement report information received from the UE 10, in step 420. Upon determining to instruct a handover, the gNB2 22 may transmit a cell switch command message by using a MAC CE in step 430. The cell switch command message may include information regarding the target cell to which the UE 10 is to hand over, and AS security information. The AS security information included in the cell switch command message may include NCC information which may indicate security key information to be used in the target cell to which the UE is to hand over. The UE 10 may use a KgNB security key associated with the NCC to be used in the target cell, or may generate an NH security key and then generate a KgNB* security key in the target cell, in step 432. In case that the cell switch command message received in step 430 includes no AS security information, and the UE 10 thus receives no NCC information for generating an AS security key in the target cell, the NCC value associated with the KgNB security key currently used in the serving cell may be increased by 1, and then used as the NCC value for generating an AS security key to be used in the target cell.

Upon determining whether or not to instruct the UE 10 to perform a layer 1/layer 2 signaling-based handover in step 420, the gNB2 22 may generate a KgNB* security key to be used in the target cell to which the UE 10 is to hand over, by using a KgNB security key which is currently used for security, or an NH security key in case that there is an NH security key received from the AMF and then stored, in step 422. Thereafter, a cell switch notification message may be transmitted to the gNB3 24 that is servicing the target cell to which the UE is to hand over in step 440. In order to transmit the cell switch notification message, the gNB 22 may transmit the cell switch notification message to the gNB1 20 in step 440, and the gNB1 20 may transmit the cell switch notification message to the gNB3 24 in step 445. The cell switch notification message may include information regarding the target cell to which the UE is to hand over, AS security information, and other information regarding layer 1/layer 2 signaling-based handovers. The gNB1 20 thus determines the gNB to which the cell switch notification message is to be transmitted from the gNB1 20, based on the target cell information included in the cell switch notification message. The AS security information included in the cell switch notification message may include NCC information associated with a KgNB* security key to be used for security in the target cell/target gNB. In case that direct communication between candidate base stations is possible as in the embodiment in FIG. 4, the gNB2 22 may transmit no cell switch notification message to the gNB1 20 in step 440, and may transmit the cell switch notification message directly to the gNB3 24. In this case, step 445 may be omitted.

Upon being instructed to perform a layer 1/layer 2 signaling-based handover in step 430, the UE 10 perform a procedure of random access to the target cell in step 450. Upon succeeding in the random access, the UE 10 may transmit an RRC message (for example, RRCConnectionReconfigurationComplete) to the gNB3 24 in step 455. Upon receiving the RRC message (for example, RRCConnectionReconfigurationComplete) from the UE 10, the gNB3 24 may transmit a handover success message to the gNB1 20 in step 460. The gNB1 20 may again transmit the handover success message to the gNB2 22 in step 465 to inform that the UE 10 has completed the layer 1/layer 2 signaling-based handover from the gNB2 22 to the gNB3 24. In case that data forwarding from the gNB2 22 to the gNB3 24 is necessary, the gNB2 22 may transmit an SN status transfer message including PDCP sequence information which is necessary for data forwarding and the like to the gNB1 20 in step 470. The gNB1 20 may transmit the SN status transfer message to the gNB3 24 in step 470. The gNB2 22 may forward data to the gNB3 24 in step 478.

The gNB3 24 may transmit a path switch request message to the 5GC 30 to inform that the UE 10 has handed over to the gNB3 24 in step 480. The 5GC 30 may transmit a path switch request acknowledge message to the gNB3 24 as a response in step 490. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy. The path switch request acknowledge message transmitted in step 490 may include security context information transferred to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 480 and 490, the UE 10 may be connected to the gNB3 24 (base station) so as to transmit/receive user packets through the gNB3 24 and 5GC 30 as in step 495.

FIG. 7C illustrates a flowchart of a UE for performing a continuous inter-base station handover based on layer 1/layer 2 signaling by using an AS security key generating method according to an embodiment of the disclosure. FIG. 7C illustrates operations which may be performed successively after the operations illustrated in FIG. 7B.

Referring to FIG. 7C, the UE 10 may perform layer 1 measurement based on signals transmitted by base stations according to the layer 1/layer 2 signaling-based handover configuration information (LTM configuration) received from the gNB1 20 in step 500.

In case that the layer 1 measurement information reporting condition is satisfied in step 510, the UE 10 may transmit a layer 1 measurement report message to the gNB3 24 by using a medium access control (MAC) control element (CE). In steps 500 and 510, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the measurement report information received from the UE 10, in step 520. Upon determining to instruct a handover, the gNB3 24 may transmit a cell switch command message by using a MAC CE in step 530. The cell switch command message may include information regarding the target cell to which the UE 10 is to hand over, and AS security information. The AS security information included in the cell switch command message may include NCC information which may indicate security key information to be used in the target cell to which the UE is to hand over. The UE 10 may use a KgNB security key associated with the NCC to be used in the target cell, or may generate an NH security key and then generate a KgNB* security key in the target cell, in step 332. In case that the cell switch command message received in step 430 includes no AS security information, and the UE 10 thus receives no NCC information for generating an AS security key in the target cell, the NCC value associated with the KgNB security key currently used in the serving cell may be increased by 1, and then used as the NCC value for generating an AS security key to be used in the target cell.

Upon determining whether or not to instruct the UE 10 to perform a layer 1/layer 2 signaling-based handover in step 520, the gNB3 24 may generate a KgNB* security key to be used in the target cell to which the UE 10 is to hand over, by using a KgNB security key which is currently used for security, or an NH security key in case that there is an NH security key received from the AMF and then stored, in step 522. Thereafter, a cell switch notification message may be transmitted to the gNB4 26 that is servicing the target cell to which the UE is to hand over in step 540. To this end, the gNB3 24 may transmit the cell switch notification message to the gNB1 20 in step 540, and the gNB1 20 may transmit the cell switch notification message to the gNB4 26 in step 545. The cell switch notification message may include information regarding the target cell to which the UE is to hand over, AS security information, and other information regarding layer 1/layer 2 signaling-based handovers. The gNB1 20 thus determines the gNB to which the cell switch notification message is to be transmitted from the gNB1 20, based on the target cell information included in the cell switch notification message. The AS security information included in the cell switch notification message may include NCC information associated with a KgNB* security key to be used for security in the target cell/target gNB. In case that direct communication between candidate base stations is possible as in the embodiment in FIG. 4, the gNB3 24 may transmit no cell switch notification message to the gNB1 20 in step 540, and may transmit the cell switch notification message directly to the gNB4 26. In this case, step 545 may be omitted.

Upon being instructed to perform a layer 1/layer 2 signaling-based handover in step 530, the UE 10 perform a procedure of random access to the target cell in step 550. Upon succeeding in the random access, the UE 10 may transmit an RRC message (for example, RRCConnectionReconfigurationComplete) to the gNB4 26 in step 555. Upon receiving the RRC message (for example, RRCConnectionReconfigurationComplete) from the UE 10, the gNB4 26 may transmit a handover success message to the gNB1 20 in step 560. The gNB1 20 may again transmit the handover success message to the gNB3 24 in step 565 to inform that the UE 10 has completed the layer 1/layer 2 signaling-based handover from the gNB3 24 to the gNB4 26. In case that data forwarding from the gNB3 24 to the gNB4 26 is necessary, the gNB3 24 may transmit an SN status transfer message including PDCP sequence information which is necessary for data forwarding and the like to the gNB1 20 in step 570. The gNB1 20 may transmit the SN status transfer message to the gNB4 26 in step 575. The gNB3 24 may forward data to the gNB4 26 in step 578.

The gNB4 26 may transmit a path switch request message to the 5GC 30 to inform that the UE 10 has handed over to the gNB4 26 in step 580. The 5GC 30 may transmit a path switch request acknowledge message to the gNB4 26 as a response in step 590. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy.

The path switch request acknowledge message transmitted in step 590 may include security context information transferred to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 580 and 590, the UE 10 may be connected to the gNB4 26 (base station) so as to transmit/receive user packets through the gNB4 26 and 5GC 30 as in step 595.

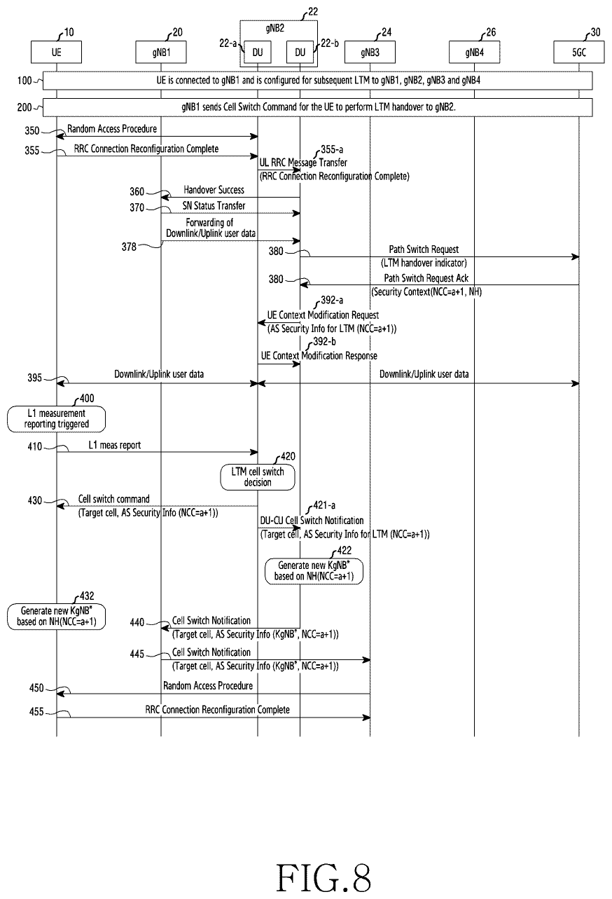

FIG. 8 illustrates a flowchart of a UE for performing a continuous inter-base station handover based on layer 1/layer 2 signaling by using an AS security key generating method according to an embodiment of the disclosure. Specifically, FIG. 8A is a signal flowchart wherein, in connection with processes in which a UE according to an embodiment of the disclosure performs a continuous inter-base station handover based on layer 1/layer 2 signaling, the UE operates by using an AS security key generating method as in FIG. 6. In FIG. 8, in order to generate an AS security key to be used in a new base station, each time the UE changes cells or base stations, changed AS security-related information for AS security key generation may be transferred from the base station to the UE by using an RRC message. In connection with processes of transferring signal messages for the UE between base stations in FIG. 8A, signal messages for the UE may be transferred between base stations through direct communication between base stations configured to support a continuous handover based on layer 1/layer 2 signaling.

Referring to FIG. 8, the UE 10 may be connected to gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200. Upon receiving the layer 3 measurement information from the UE 10 in step 200, the gNB 20 may determine whether or not to perform a configuration for performing a layer 1/layer 2 signaling-based handover for the UE 10 in step 210, and may determine to perform a layer 1/layer 2 signaling-based handover. In addition, the gNB 20 may determine the target cell to which the UE may hand over and gNBs including the target cell. The gNB1 20 may generate a KgNB* security key to be used in each candidate cell to which the UE 10 may hand over, by using a KgNB security key which is currently used for security, or an NH security key in case that there is an NH security key received from the AMF and then stored, in step 215, or may thereafter generate the same in step 322 in which the UE is instructed to change cells. In connection with the KgNB* security key generated in step 215, each candidate cell's PCI and DL frequency information may differ, and a different KgNB* security key may thus be generated for each candidate cell.

The gNB1 20 may transmit handover request messages for configuring a layer 1/layer 2 signaling-based handover to gNBs determined in step 210, particularly to the gNB2 22, the gNB3 24, and the gNB4 26, respectively, in steps 220, 222, and 224. The handover request message may include information for LTM configurations and indicators such as L1/L2 triggered mobility (LTM) initiations indicating that a handover is to be configured based on layer 1/layer 2 signaling, and may also include AS security information. Meanwhile, the AS security information may not be included in the handover request messages transmitted in steps 220, 222, and 224, or may be included in the cell switch notification message transmitted in step 340 to the target base station when the UE changes cells. The AS security information may include NCC information associated with a KgNB* security key to be used for security in each candidate cell/candidate gNB. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 in step 240, 242, and 244, respectively.

The gNB1 20 may generate layer 1/layer 2 signaling-based handover configuration information (LTM configuration) to be transmitted to the UE, based on acknowledge messages received from the gNB2 22, the gNB3 24, and the gNB4 26, respectively, in step 250. The gNB1 20 may transmit layer 1/layer 2 signaling-based handover configuration information to the UE 10 by using an RRC message (for example, RRCConnectionReconfiguration message) in step 260. The UE 10 may transmit an RRC message (for example, RRCConnectionReconfigurationComplete) to the gNB1 20 as a response in step 270. The RRC message (for example, RRCConnectionReconfiguration message) that the UE 10 has received from the gNB1 20 in step 260 may include AS security information, and the AS security information may include NCC information which may indicate security key information to be used during a handover to a candidate cell. In addition, the AS security information may not be included in the RRCConnectionReconfiguration message transmitted from the gNB1 20 to the UE 10 in step 260. Thereafter, the gNB1 20 may transfer the AS security information to the UE 10 through an additional RRC procedure which is not included in FIG. 8A, by using a new RRC message.

Upon receiving acknowledge messages from all gNBs to which handover request messages have been transmitted in steps 240, 242, and 244, the gNB1 20 may transmit messages including information regarding candidate cells to which the UE may move, information regarding candidate gNBs, target node UE XnAP ID or reference UE XnAP ID information allocated to identify the UE in each candidate gNB, and information regarding data forwarding in respective base stations, which is to be used for inter-base station data forwarding during the UE's handover, to the gNB2 22, the gNB3 24, and the gNB4 26 in steps 262, 264, and 266, respectively. In connection with LTM configuration update messages transmitted by the gNB1 20 in steps 262, 264, and 266, Xn-U address indication messages or other Xn messages may be defined and used. In case that LTM configuration update messages are used in steps 262, 264, and 266, the gNB2 22, the gNB3 24, and the gNB4 26 may transmit LTM configuration update acknowledges to the gNB1 20 in steps 272, 274, and 276, respectively.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 300, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. Upon determining to instruct a handover, the gNB1 20 may transmit a cell switch command message by using a MAC CE in step 330. The cell switch command message may include information regarding the target cell to which the UE 10 is to hand over. The UE 10 may use a KgNB security key associated with the NCC to be used in the target cell, or may generate an NH security key and then generate a KgNB* security key in the target cell, in step 332.

Upon determining whether or not to instruct the UE 10 to perform a layer 1/layer 2 signaling-based cell switch or handover in step 320, the gNB1 20 may generate a KgNB* security key to be used in the target cell to which the UE 10 is to hand over, by using a KgNB security key which is currently used for security, or an NH security key in case that there is an NH security key received from the AMF and then stored, in step 322. In addition, a cell switch notification message may be transmitted to the gNB2 22 that is servicing the target cell to which the UE is to hand over in step 340, and the cell switch notification message may include target node UE XnAP ID or reference UE XnAP ID information allocated to identify the UE in the target gNB, information regarding the target cell to which the UE is to hand over, and other information regarding layer 1/layer 2 signaling-based handovers, and may also include AS security information. The AS security information included in the cell switch notification message may include NCC information associated with a KgNB* security key to be used for security in the target cell/target gNB.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) protected based on the newly generated AS security key to the gNB2 22 in step 355.

Upon receiving an RRC message (for example, RRCConnectionReconfigurationComplete) from the UE 10, the gNB2 22 may transmit a handover success message to the gNB1 20 in step 360, thereby informing that the UE 10 has completed a layer 1/layer 2 signaling-based handover to the gNB2 22. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 transmits a path switch request message to the 5GC 30 to inform that the UE 10 has handed over to the gNB2 22 in step 380. The 5GC 30 may transmit a path switch request acknowledge message to the gNB2 22 as a response in step 390. The path switch request acknowledge message transmitted in step 390 may include security context information transmitted to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

In case that the gNB2 22 receives the security context information transferred from the 5GC in step 390, the gNB2 22 may transfer new AS security information to the UE 10 by using an RRC message (for example, RRCConnectionReconfiguration message) or a newly defined RRC message in step 400. The AS security information may include NCC information which may indicate security key information to be used during a new handover to another candidate cell. The UE 10 may transmit an RRC message (for example, RRCConnectionReconfigurationComplete message) or a new RRC acknowledge message to the gNB 22 as a response in step 410.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 500, the UE 10 may transmit a layer 1 measurement report message to the gNB2 22 by using a medium access control (MAC) control element (CE) in step 510. In steps 500 and 510, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the layer 1 measurement report information received from the UE 10, in step 520. Upon determining to instruct a handover, the gNB2 22 may transmit a cell switch command message by using a MAC CE in step 530. The cell switch command message may include information regarding the target cell to which the UE 10 is to hand over. The UE 10 may use a KgNB security key associated with the NCC to be used in the target cell, which has been received from the gNB2 22 in step 400, or may generate an NH security key and then generate a KgNB* security key in the target cell, in step 532.

Upon determining whether or not to instruct the UE 10 to perform a layer 1/layer 2 signaling-based handover in step 520, the gNB2 22 may generate KgNB* security key to be used in the target cell to which the UE 10 is to hand over, by using a KgNB security key which is currently used for security, or an NH security key in case that there is an NH security key received from the AMF and then stored, in step 522. Thereafter, a cell switch notification message may be transmitted to the gNB3 24 that is servicing the target cell to which the UE is to hand over in step 540. The cell switch notification message may include target node UE XnAP ID or reference UE XnAP ID information allocated to identify the UE in the target gNB, information regarding the target cell to which the UE is to hand over, AS security information, and other information regarding layer 1/layer 2 signaling-based handovers. The AS security information included in the cell switch notification message may include NCC information associated with a KgNB* security key to be used for security in the target cell/target gNB.

Upon being instructed to perform a layer 1/layer 2 signaling-based handover in step 530, the UE 10 perform a procedure of random access to the target cell in step 550. Upon succeeding in the random access, the UE 10 may transmit an RRC message (for example, RRCConnectionReconfigurationComplete) protected based on the newly generated AS security key to the gNB3 24 in step 555.

Upon receiving the RRC message (for example, RRCConnectionReconfigurationComplete) from the UE 10, the gNB3 24 may transmit a handover success message to the gNB2 22 in step 560, thereby informing that the UE 10 has completed the layer 1/layer 2 signaling-based handover from the gNB2 22 to the gnB3 24. In case that data forwarding from the gNB2 22 to the gNB3 24 is necessary, the gNB2 22 may transmit an SN status transfer message including PDCP sequence information which is necessary for data forwarding and the like to the gNB3 24 in step 570. The gNB2 22 may forward data to the gNB3 24 in step 578.

The gNB3 24 may transmit a path switch request message to the 5GC 30 to inform that the UE 10 has handed over to the gNB3 24 in step 580. The 5GC 30 may transmit a path switch request acknowledge message to the gNB3 24 as a response in step 590. The path switch request acknowledge message transmitted in step 590 may include security context information transferred to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 580 and 590, the UE 10 may be connected to the gNB3 24 (base station) so as to transmit/receive user packets through the gNB3 24 and 5GC 30 as in step 595.

In case that the gNB3 24 receives the security context information transferred from the 5GC in step 590, the gNB3 24 may transfer new AS security information to the UE 10 by using an RRC message (for example, RRCConnectionReconfiguration message) or a newly defined RRC message in step 600. The AS security information may include NCC information which may indicate security key information to be newly used during a cell change or handover to another candidate cell. The UE 10 may transmit an RRC message (for example, RRCConnectionReconfigurationComplete message) or a new RRC acknowledge message to the gNB324 as a response in step 610.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 700, the UE 10 may transmit a layer 1 measurement report message to the gNB3 24 by using a medium access control (MAC) control element (CE) in step 710. In steps 700 and 710, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the layer 1 measurement report information received from the UE 10, in step 720. Upon determining to instruct a handover, the gNB3 24 may transmit a cell switch command message by using a MAC CE in step 730. The cell switch command message may include information regarding the target cell to which the UE 10 is to hand over. The UE 10 may use a KgNB security key associated with the NCC to be used in the target cell, which has been received from the gNB3 24 in step 600, or may generate an NH security key and then generate a KgNB* security key in the target cell, in step 732.

Upon determining whether or not to instruct the UE 10 to perform a layer 1/layer 2 signaling-based handover in step 720, the gNB3 24 may generate KgNB* security key to be used in the target cell to which the UE 10 is to hand over, by using a KgNB security key which is currently used for security, or an NH security key in case that there is an NH security key received from the AMF and then stored, in step 722. Thereafter, a cell switch notification message may be transmitted to the gNB4 26 that is servicing the target cell to which the UE is to hand over in step 740. The cell switch notification message may include target node UE XnAP ID or reference UE XnAP ID information allocated to identify the UE in the target gNB, information regarding the target cell to which the UE is to hand over, AS security information, and other information regarding layer 1/layer 2 signaling-based handovers. The AS security information included in the cell switch notification message may include NCC information associated with a KgNB* security key to be used for security in the target cell/target gNB.

Upon being instructed to perform a layer 1/layer 2 signaling-based handover in step 730, the UE 10 perform a procedure of random access to the target cell in step 750. Upon succeeding in the random access, the UE 10 may transmit an RRC message (for example, RRCConnectionReconfigurationComplete) to the gNB4 26 in step 755.

Upon receiving the RRC message (for example, RRCConnectionReconfigurationComplete) from the UE 10, the gNB4 26 may transmit a handover success message to the gNB3 24 in step 760, thereby informing that the UE 10 has completed the layer 1/layer 2 signaling-based handover from the gNB3 24 to the gNB4 26. In case that data forwarding from the gNB3 24 to the gNB4 26 is necessary, the gNB3 24 may transmit an SN status transfer message including PDCP sequence information which is necessary for data forwarding and the like to the gNB4 26 in step 770. The gNB3 24 may forward data to the gNB4 26 in step 778.

The gNB4 26 may transmit a path switch request message to the 5GC 30 to inform that the UE 10 has handed over to the gNB4 26 in step 780. The 5GC 30 may transmit a path switch request acknowledge message to the gNB4 26 as a response in step 790. The path switch request acknowledge message transmitted in step 790 may include security context information transferred to the base station. The security context information may include NCC information associated with a new NH security key. The base station may store the security context information received from the 5GC and may then use the same to generate an AS security key to be used in the target cell/target base station when the UE performs a handover.

In case that the UE 10 completes the handover procedure by performing the procedure in steps 780 and 790, the UE 10 may be connected to the gNB4 26 (base station) so as to transmit/receive user packets through the gNB4 26 and 5GC 30 as in step 795.

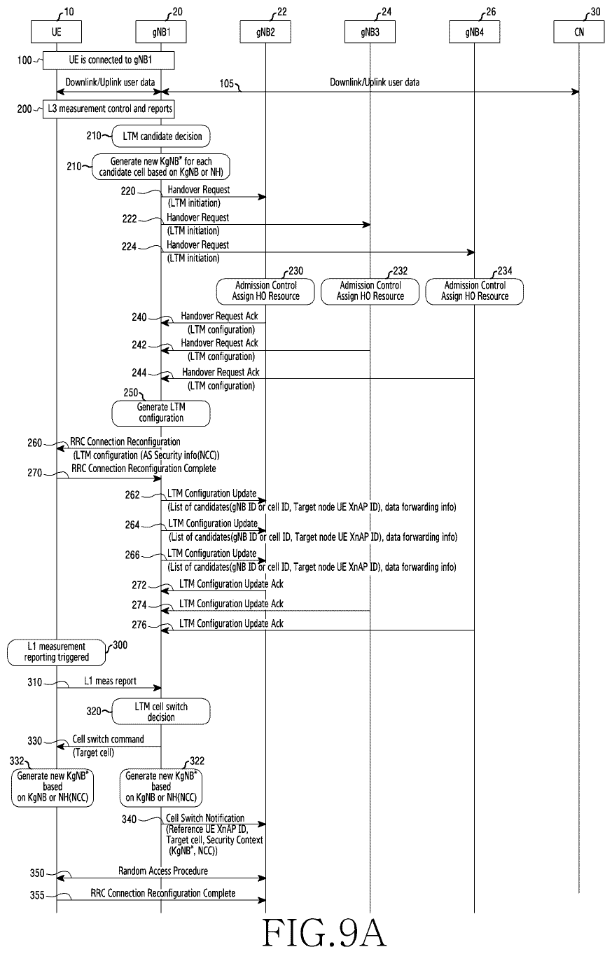

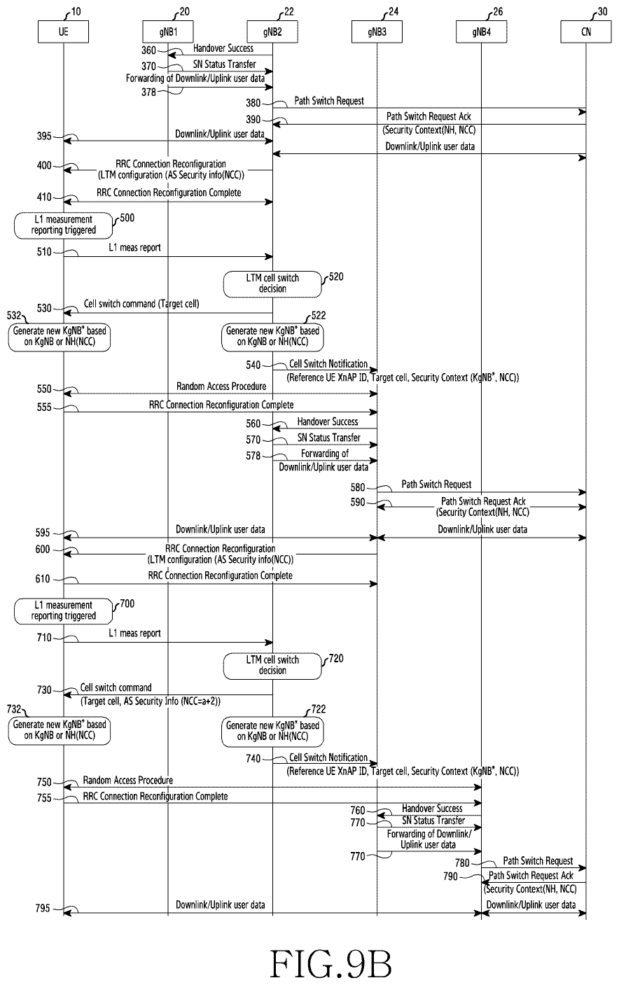

FIG. 9A illustrates a signal flowchart between a gNB-CU and a gNB-DU in a structure in which a gNB according to an embodiment of the disclosure is divided into a gNB-central unit (CU) and a gNB-distributed unit (DU). The signal flow procedure in FIG. 9A-9B corresponds to the signal procedure from step 350 to step 455 in FIG. 7A and FIG. 7B.

Referring to FIG. 9A, the UE 10 may be connected to the gNB1 20 (base station) such that the gNB1 20 interworks with the gNB2 22, the gNB3 24, and the gNB4 26, thereby configuring a layer 1/layer 2 signaling-based handover, in step 100. The UE 10 may complete the procedure of layer 1/layer 2 signaling-based handover from the gNB1 20 to the gNB2 22, based on the layer 1/layer 2 signaling-based handover information configured in step 100, in step 200. Upon being instructed by the gNB1 20 to perform a layer 1/layer 2 signaling-based handover, the UE 10 may perform a procedure of random access to the target cell in step 350. Upon succeeding in the random access, the UE 10 may transmit an RRC message (for example, RRCConnectionReconfigurationComplete) to the gNB2 22 in step 355. The RRC message (for example, RRCConnectionReconfigurationComplete) transmitted by the UE 10 in step 355 may be received by the gNB2-DU 22-a. The gNB2-DU 22-a may transmit a UL RRC message transfer message to the gNB2-CU 22-b in step 355. The UL RRC message transfer message may include the RRC message (for example, RRCConnectionReconfigurationComplete) transmitted by the UE 10.

FIG. 9B illustrates a signal flowchart between a gNB-CU and a gNB-DU in a structure in which a gNB according to an embodiment of the disclosure is divided into a gNB-central unit (CU) and a gNB-distributed unit (DU) according to an embodiment of the disclosure. FIG. 9B illustrates operations which may be performed successively after the operations illustrated in FIG. 9A.

Referring to FIG. 9B, upon receiving the RRC message (for example, RRCConnectionReconfigurationComplete) from the UE 10, the gNB2-CU 22-b may transmit a handover success message to the gNB1 20 to inform that the UE 10 has completed the layer 1/layer 2 signaling-based handover to the gNB2 22 in step 360. In case that data forwarding from the gNB1 20 to the gNB2-CU 22-b, the gNB1 20 may transmit an SN status transfer message including PDCP sequence information which is necessary for data forwarding and the like to the gNB2-CU 22-b in step 370, and the gNB1 20 may forward data to the gNB2-CU 22-b in step 378.

The gNB2-CU 22-b may transmit a path switch request message to the 5GC 30 to inform that the UE 10 has handed over to the gNB2 22 in step 380. The 5GC 30 may transmit a path switch request acknowledge message to the gNB2-CU 22-b as a response in step 390. The path switch request message may include an indicator such as an LTM handover indicator which indicates that the UE has performed a layer 1/layer 2 signaling-based handover. Upon receiving the LTM handover indicator, the 5GC may perform necessary operations, such as configuring the UE's policy. The path switch request acknowledge message transmitted in step 390 may include security context information transmitted to the base station. The security context information may include NCC information associated with a new NH security key. The base station may store the security context information received from the 5GC and may then use the same to generate an AS security key to be used in the target cell/target base station when the UE performs a handover.

In case that the gNB2-CU 22-b receives security context information from the AMF in step 390, the gNB2-CU 22-b transmits a UE context modification request message to the gNB2-DU 22-a in step 392-a. The UE context modification request message may include AS security information to be used in the target cell after the UE 10 hands over, and the AS security information may include NCC information. Upon receiving the UE context modification request message from the gNB2-CU 22-b, the gNB2-DU 22-a may transmit a UE context modification response message to the gNB2-CU 22-b as a response in step 392-b. In case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 400, the UE 10 may transmit a layer 1 measurement report message to the gNB2-DU 22-a by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2-DU 22-a may determine whether or not to instruct the UE 10 to perform a layer 1/layer 2 signaling-based handover, based on the measurement report information received from the UE 10, in step 420. Upon determining to instruct a handover, the gNB2-DU 22-a may transmit a cell switch command message by using a MAC CE in step 430. The cell switch command message may include information regarding the target cell to which the UE 10 is to hand over, and AS security information. The AS security information included in the cell switch command message may include NCC information transferred from the gNB2-CU 22-b to the gNB2-DU 22-a in step 392-a, and the NCC information may indicate security key information to be used in the target cell to which the UE is to hand over. In step 432, the UE 10 may use a KgNB security key associated with the NCC to be used in the target cell, or may generate an NH security key and then generate a KgNB* security key in the target cell. In case that the cell switch command message received in step 430 includes no AS security information, and the UE 10 thus receives no NCC information for generating an AS security key in the target cell, the NCC value associated with the KgNB security key currently used in the serving cell may be increased by 1, and then used as the NCC value for generating an AS security key to be used in the target cell.

Upon determining whether or not to instruct the UE 10 to perform a layer 1/layer 2 signaling-based handover in step 420, the gNB2-DU 22-a may transmit a DU-CU cell switch notification message to the gNB2-CU 22-b in step 421-a. The DU-CU cell switch notification message may include information regarding the target cell to which the UE 10 is to hand over, and security information including NCC information transferred to the UE. The gNB2-CU 22-b may generate a KgNB* security key to be used in the target cell to which the UE 10 is to hand over, by using a KgNB security key which is currently used for security, or an NH security key in case that there is an NH security key received from the AMF and then stored, in step 422. In addition, a cell switch notification message may be transmitted to the gNB3 24 that is servicing the target cell to which the UE is to hand over in step 440. To this end, the gNB2-CU 22-b may transmit the cell switch notification message to the gNB1 20 in step 440, and the gNB1 20 may transmit the cell switch notification message to the gNB3 24 in step 445. The cell switch notification message may include information regarding the target cell to which the UE is to hand over, AS security information, and other information regarding layer 1/layer 2 signaling-based handovers. The gNB1 20 thus determines the gNB to which the cell switch notification message is to be transmitted from the gNB1 20, based on the target cell information included in the cell switch notification message. The AS security information included in the cell switch notification message may include NCC information associated with a KgNB* security key to be used for security in the target cell/target gNB.

Upon being instructed to perform a layer 1/layer 2 signaling-based handover in step 430, the UE 10 may perform a procedure of random access to the target cell in step 450. Upon succeeding in the random access, the UE 10 may transmit an RRC message (for example, RRCConnectionReconfigurationComplete) to the gNB3 24 in step 455.

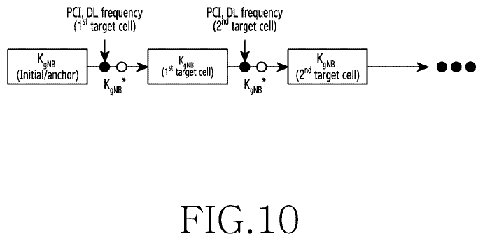

FIG. 10 illustrates a method for generating a security key for ciphering and integrity protection in a UE and a base station according to an embodiment of the disclosure.

Specifically, FIG. 10 illustrates another method for generating a security key for ciphering and integrity protection in a UE and a base station in case that the UE performs a layer 1/layer 2 signaling-based handover.

In FIG. 10, in case that a layer 1/layer 2 signaling-based handover is configured, the vertical key generating process in FIG. 6 is not used. After the UE completes the handover, the AFM of the 5GC may not increase the NCC value used for AS security of the UE and the base station, and may not generate a new NH security key.

In FIG. 10, in case that the UE performs a handover based on a KgNB security key of a gNB having a layer 1/layer 2 signaling-based handover configured therefor, the NCC value may not be changed because only a horizontal key is generated such that the KgNB* to be used in the target cell/target base station is continuously generated. In case that the UE performs a layer 1/layer 2 signaling-based handover, the AS security key to be used between the UE and target gNB is generated in the currently generated KgNB, and may be generated by using information such as a physical cell identifier (PCI) used in the target cell, downlink frequency (ARFCN-DL), and the like.

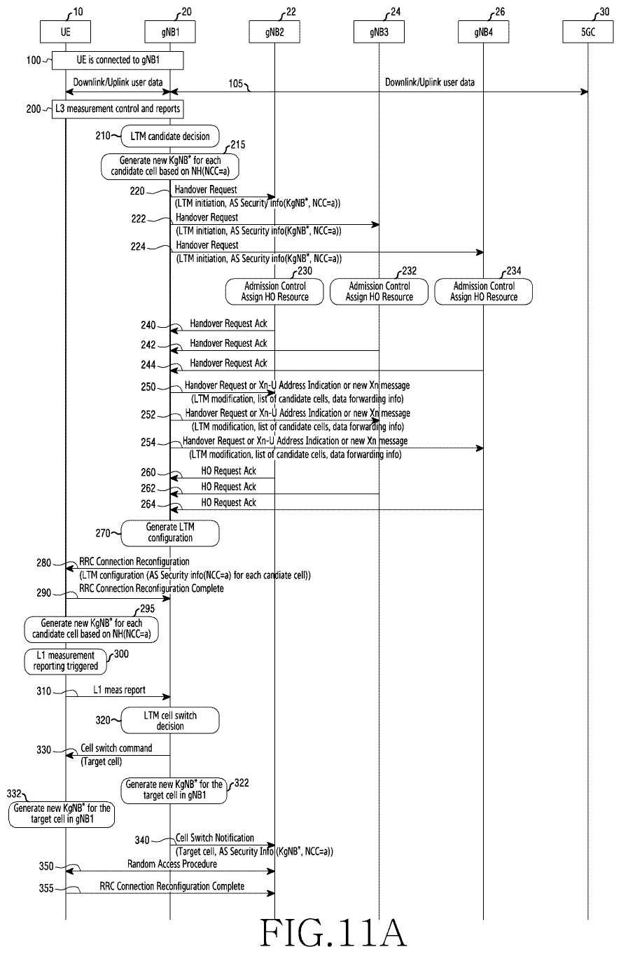

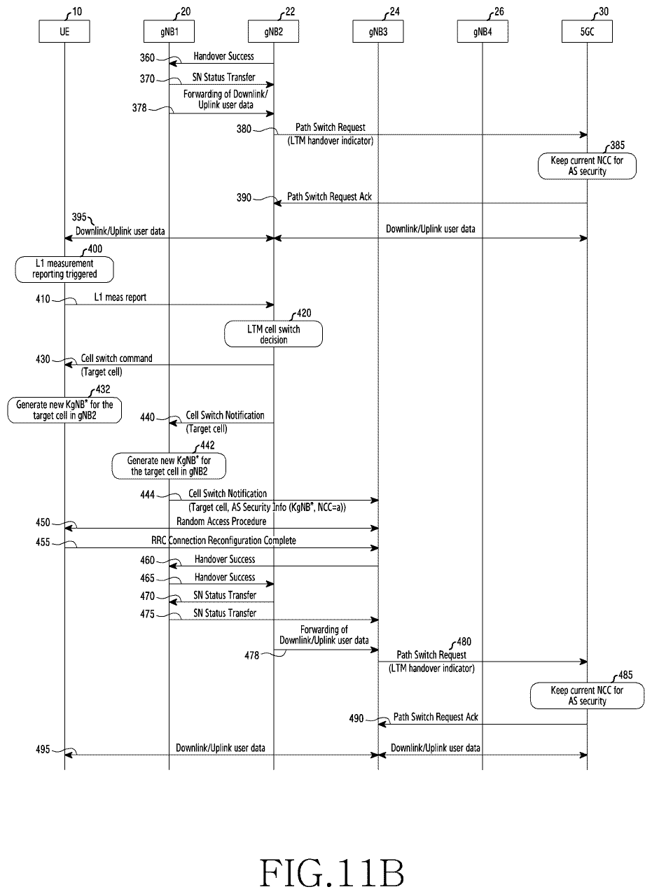

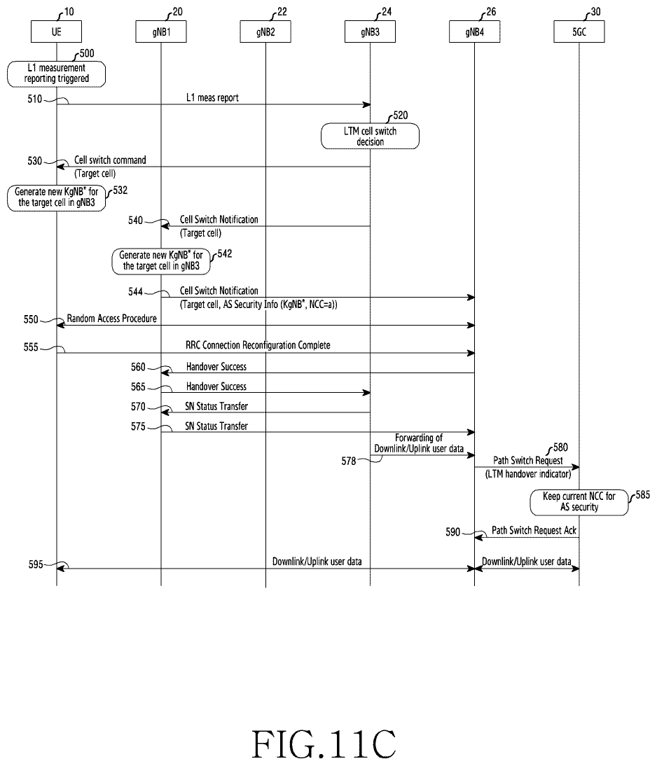

FIG. 11A, FIG. 11B, and FIG. 11C illustrate flowcharts of processes in which a UE according to an embodiment of the disclosure performs a continuous inter-base station handover based on layer 1/layer 2 signaling by using an AS security key generating method.

FIG. 11A illustrates a flowchart of a UE according to an embodiment of the disclosure performs a continuous inter-base station handover based on layer 1/layer 2 signaling by using an AS security key generating method. Specifically, FIG. 11A, FIG. 11B, and FIG. 11C are signal flowcharts wherein, in connection with processes in which a UE according to an embodiment of the disclosure performs a continuous inter-base station handover based on layer 1/layer 2 signaling, the UE operates by using an AS security key generating method as in FIG. 9. In connection with processes of transferring signal messages for the UE between base stations in FIG. 11A, FIG. 11B, and FIG. 11C, signal messages for the UE may be transferred between base stations through a base station for which a continuous inter-base station handover based on layer 1/layer 2 signaling is configured first.

Referring to FIG. 11A, the UE 10 may be connected to gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200. Upon receiving the layer 3 measurement information from the UE 10 in step 200, the gNB 20 may determine whether or not to perform a configuration for performing a layer 1/layer 2 signaling-based handover for the UE 10 in step 210, may determine to perform a layer 1/layer 2 signaling-based handover, and may determine the target cell to which the UE may hand over and gNBs including the target cell. In step 215, the gNB1 20 may generate a KgNB* security key which is to be used in each candidate cell to which the UE 10 may hand over, by using a KgNB security key which is currently used for security or an NH security key in case that there is an NH security key which has been received from the AMF and then stored therein. In connection with the KgNB* security key generated in step 215, each candidate cell's PCI and DL frequency information may differ, and a different KgNB* security key may accordingly be generated for each candidate cell.

The gNB1 20 may transmit handover request messages for configuring a layer 1/layer 2 signaling-based handover to gNBs determined in step 210, particularly to gNB2 22, the gNB3 24, and the gNB4 26, respectively, in steps 220, 222, and 224. The handover request messages may include an indicator such as L1/L2 triggered mobility (LTM) initiation indicating that a handover is to be configured based on layer 1/layer 2 signaling, AS security information, information for LTM configurations, and the like. The AS security information may include NCC information associated with a KgNB* security key to be used for security in each candidate cell/candidate gNB. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 in step 240, 242, and 244, respectively.

Upon receiving acknowledge messages from all gNBs to which handover request messages have been transmitted, the gNB1 20 may transmit messages including information regarding candidate cells to which the UE may move, information regarding candidate gNBs, and information regarding data forwarding in respective base stations, which is to be used for inter-base station data forwarding during the UE's handover, to the gNB2 22, the gNB3 24, and the gNB4 26 in steps 250, 252, and 254, respectively. The messages transmitted by the gNB1 20 in steps 250, 252, and 254 may include indicators such as LTM modification in handover request messages, or Xn-U address indication messages or new messages may be defined and used. In case that handover request messages are used in steps 250, 252, and 254, the gNB2 22, the gNB3 24, and the gNB4 26 may transmit handover request acknowledge messages to the gNB1 20 in step 260, 262, and 264, respectively.

The gNB1 20 generates layer 1/layer 2 signaling-based handover configuration information (LTM configuration) to be transmitted to the UE, based on acknowledge messages received from the gNB2 22, the gNB3 24, and the gNB4 26, respectively, in step 270. The gNB1 20 transmits layer 1/layer 2 signaling-based handover configuration information to the UE 10 by using an RRC message (for example, RRCConnectionReconfiguration message) in step 280. The UE 10 may transmit an RRC message (for example, RRCConnectionReconfigurationComplete) to the gNB1 20 as a response in step 290. The RRC message (for example, RRCConnectionReconfiguration message) that the UE 10 has received from the gNB1 20 in step 280 may include each candidate cell-specific AS security information, and the AS security information includes NCC information which may indicate security key information to be used during a handover to the corresponding candidate cell. In step 295, the UE 10 may use a KgNB security key associated with the NCC transferred with regard to each candidate cell, or may generate an NH security key and then generate a new KgNB* security key with regard to each candidate cell.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 300, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. Upon determining to instruct a handover, the gNB1 20 may transmit a cell switch command message by using a MAC CE in step 330. The cell switch command message may include information regarding the target cell to which the UE 10 is to hand over. Instead of generating and storing an AS security key in step 295, the UE 10 may generate a KgNB* security key in the target cell by using the KgNB security key in the current serving cell and the target cell's PCI and DL frequency information, in step 332.

Upon determining whether or not to instruct the UE 10 to perform a layer 1/layer 2 signaling-based handover in step 320, the gNB1 20 may generate a KgNB* security key in the target cell by using the KgNB security key which is currently used for the UE 10 and the target cell's PCI and DL frequency information, in step 322. A cell switch notification message may be transmitted to the gNB2 22 that is servicing the target cell to which the UE is to hand over in step 340, and the cell switch notification message may include information regarding the target cell to which the UE is to hand over, AS security information, and other information regarding layer 1/layer 2 signaling-based handovers. The AS security information included in the cell switch notification message may include NCC information associated with a KgNB* security key to be used for security in the target cell/target gNB.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) to the gNB2 22 in step 355.

FIG. 11B illustrates a flowchart of a UE for performing a continuous inter-base station handover based on layer 1/layer 2 signaling by using an AS security key generating method according to an embodiment of the disclosure. FIG. 11B may illustrate operations which may be performed successively after the operations in FIG. 11A.

Referring to FIG. 11B, upon receiving an RRC message (for example, RRCConnectionReconfigurationComplete) from the UE 10, the gNB2 22 may transmit a handover success message to the gNB1 20 in step 360, thereby informing that the UE 10 has completed a layer 1/layer 2 signaling-based handover to the gNB2 22. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 may transmit a path switch request message to the 5GC 30 to inform that the UE 10 has handed over to the gNB2 22 in step 380. The 5GC 30 may transmit a path switch request acknowledge message to the gNB2 22 as a response in step 390. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy. In step 385, the 5GC 30 (the 5GC's AMF) may not increase the NCC value used for AS security of the UE and the base station, and may not generate a new NH security key. The path switch request acknowledge message transmitted to the gNB2 22 in step 390 may include no security context information transmitted to the base station, or may include dummy information. In case that the path switch request acknowledge message includes security context information, the gNB2 22 may not use corresponding information.

In case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20 in step 400. Thereafter, in case that the layer 1 measurement information reporting condition is satisfied, the UE 10 may transmit a layer 1 measurement report message to the gNB2 22 by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the measurement report information received from the UE 10, in step 420. In addition, upon determining to instruct a handover, the gNB2 22 may transmit a cell switch command message by using a MAC CE in step 430. The cell switch command message may include information regarding the target cell to which the UE 10 is to hand over. The UE 10 may generate a KgNB* security key in the target cell by using the KgNB security key in the current serving cell and the target cell's PCI and DL frequency information, in step 432.

Upon determining whether or not to instruct the UE 10 to perform a layer 1/layer 2 signaling-based handover in step 420, the gNB2 22 may transmit a cell switch notification message to the gNB3 24 that is servicing the target cell to which the UE is to hand over in step 440. To this end, the gNB2 22 may transmit the cell switch notification message to the gNB1 20 in step 440, and the gNB1 20 may transmit the cell switch notification message to the gNB3 24 in step 445. The cell switch notification message may include information regarding the target cell to which the UE is to hand over, and other information regarding layer 1/layer 2 signaling-based handovers. The gNB1 20 thus determines the gNB to which the cell switch notification message is to be transmitted from the gNB1 20, based on the target cell information included in the cell switch notification message. Upon receiving the cell switch notification message from the gNB2 22 in step 440, the gNB1 20 may generate a KgNB* security key in the target cell by using the KgNB security key which is currently used for security in the gNB2 22 and the target cell's PCI and DL frequency information, in step 442. The cell switch notification message transmitted from the gNB1 20 to the gNB3 24 in step 444 may include information regarding the target cell to which the UE is to hand over, AS security information, and other information regarding layer 1/layer 2 signaling-based handovers. The AS security information included in the cell switch notification message may include NCC information associated with the KgNB* security key to be used for security in the target cell/target gNB, generated in step 442.

Upon being instructed to perform a layer 1/layer 2 signaling-based handover in step 430, the UE 10 perform a procedure of random access to the target cell in step 450. Upon succeeding in the random access, the UE 10 may transmit an RRC message (for example, RRCConnectionReconfigurationComplete) to the gNB3 24 in step 455. Upon receiving the RRC message (for example, RRCConnectionReconfigurationComplete) from the UE 10, the gNB3 24 may transmit a handover success message to the gNB1 20 in step 460. The gNB1 20 may again transmit the handover success message to the gNB2 22 in step 465 to inform that the UE 10 has completed the layer 1/layer 2 signaling-based handover from the gNB2 22 to the gNB3 24. In case that data forwarding from the gNB2 22 to the gNB3 24 is necessary, the gNB2 22 may transmit an SN status transfer message including PDCP sequence information which is necessary for data forwarding and the like to the gNB1 20 in step 470. The gNB1 20 transmits the SN status transfer message to the gNB3 24 in step 470. The gNB2 22 forwards data to the gNB3 24 in step 478.

The gNB3 24 may transmit a path switch request message to the 5GC 30 to inform that the UE 10 has handed over to the gNB3 24 in step 480. The 5GC 30 may transmit a path switch request acknowledge message to the gNB3 24 as a response in step 490. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy. In step 485, the 5GC 30 (the 5GC's AMF) may not increase the NCC value used for AS security of the UE and the base station, and may not generate a new NH security key. The path switch request acknowledge message transmitted from the 5GC 30 to the gNB3 24 in step 490 may include no security context information transmitted to the base station, or may include dummy information. According to an embodiment of the disclosure, in case that the path switch request acknowledge message includes security context information, the gNB3 24 may not use corresponding information.

In case that the UE 10 completes the handover procedure by performing the procedure in steps 480 and 490, the UE 10 may be connected to the gNB3 24 (base station) so as to transmit/receive user packets through the gNB3 24 and 5GC 30 in step 495.

FIG. 11C illustrates a flowchart of a UE for performing a continuous inter-base station handover based on layer 1/layer 2 signaling by using an AS security key generating method according to an embodiment of the disclosure. FIG. 11C may illustrate operations which may be performed successively after the operations in FIG. 11B.

Referring to FIG. 11C, the UE 10 may perform layer 1 measurement based on signals transmitted by base stations according to the layer 1/layer 2 signaling-based handover configuration information (LTM configuration) received from the gNB1 20 in step 500. In case that the layer 1 measurement information reporting condition is satisfied in step 510, the UE 10 may transmit a layer 1 measurement report message to the gNB3 24 by using a medium access control (MAC) control element (CE). In steps 500 and 510, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the measurement report information received from the UE 10, in step 520. Upon determining to instruct a handover, the gNB3 24 may transmit a cell switch command message by using a MAC CE in step 530. The cell switch command message may include information regarding the target cell to which the UE 10 is to hand over. The UE 10 may generate a KgNB* security key in the target cell by using the KgNB security key in the current serving cell and the target cell's PCI and DL frequency information, in step 532.

Upon determining whether or not to instruct the UE 10 to perform a layer 1/layer 2 signaling-based handover in step 520, the gNB3 24 may transmit a cell switch notification message to the gNB4 26 that is servicing the target cell to which the UE is to hand over in step 540. To this end, the gNB3 24 may transmit the cell switch notification message to the gNB1 20 in step 540, and the gNB1 20 may transmit the cell switch notification message to the gNB4 26 in step 545. The cell switch notification message may include information regarding the target cell to which the UE is to hand over, and other information regarding layer 1/layer 2 signaling-based handovers. The gNB1 20 thus determines the gNB to which the cell switch notification message is to be transmitted from the gNB1 20, based on the target cell information included in the cell switch notification message.

The gNB1 20 may receive the cell switch notification message from the gNB3 24 in step 540. The gNB1 20 may generate a KgNB* security key in the target cell by using the KgNB security key which is currently used for security in the gNB3 24 and the target cell's PCI and DL frequency information, in step 542. The cell switch notification message transmitted from the gNB1 20 to the gNB4 26 in step 544 may include information regarding the target cell to which the UE is to hand over, AS security information, and other information regarding layer 1/layer 2 signaling-based handovers. The AS security information included in the cell switch notification message may include NCC information associated with the KgNB* security key to be used for security in the target cell/target gNB, generated in step 542.

Upon being instructed to perform a layer 1/layer 2 signaling-based handover in step 530, the UE 10 perform a procedure of random access to the target cell in step 550. Upon succeeding in the random access, the UE 10 may transmit an RRC message (for example, RRCConnectionReconfigurationComplete) to the gNB4 26 in step 555. Upon receiving the RRC message (for example, RRCConnectionReconfigurationComplete) from the UE 10, the gNB4 26 may transmit a handover success message to the gNB1 20 in step 560. The gNB1 20 may again transmit the handover success message to the gNB3 24 in step 565 to inform that the UE 10 has completed the layer 1/layer 2 signaling-based handover from the gNB3 24 to the gNB4 26.

In step 570, in case that data forwarding from the gNB3 24 to the gNB4 26 is necessary, the gNB3 24 may transmit an SN status transfer message including PDCP sequence information which is necessary for data forwarding and the like to the gNB1 20. The gNB1 20 may transmit the SN status transfer message to the gNB4 26 in step 570. The gNB3 24 may forward data to the gNB4 26 in step 578.

The gNB4 26 may transmit a path switch request message to the 5GC 30 to inform that the UE 10 has handed over to the gNB4 26 in step 580. The 5GC 30 may transmit a path switch request acknowledge message to the gNB4 26 as a response in step 590. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy. In step 585, the 5GC 30 (the 5GC's AMF) may not increase the NCC value used for AS security of the UE and the base station, and may not generate a new NH security key. The path switch request acknowledge message transmitted from the 5GC 30 to the gNB4 26 in step 590 may include no security context information transmitted to the base station, or may include dummy information. In case that the path switch request acknowledge message includes security context information, the gNB4 26 does not use corresponding information.

In case that the UE 10 completes the handover procedure by performing the procedure in steps 580 and 590, the UE 10 may be connected to the gNB4 26 (base station) so as to transmit/receive user packets through the gNB4 26 and 5GC 30 in step 595.

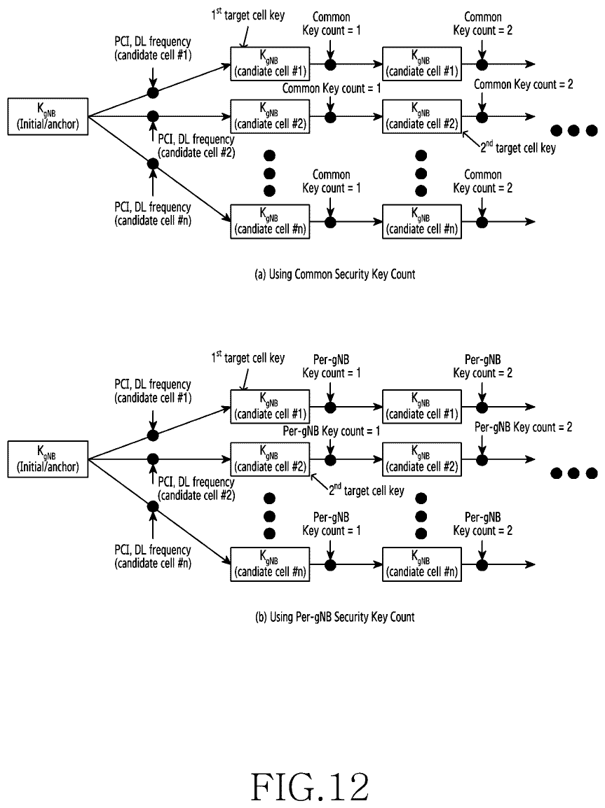

FIG. 12 illustrates processes of generating a security key for ciphering and integrity protection in a UE and a base station in case that the UE performs a layer 1/layer 2 signaling-based handover according to an embodiment of the disclosure.

In FIG. 12, in case that a layer 1/layer 2 signaling-based handover is configured, the vertical key generating process in FIG. 6 is not used. After the UE completes the handover, the AFM of the 5GC may not increase the NCC value used for AS security of the UE and the base station, and may not generate a new NH security key.

In FIG. 12, in case that the UE performs a handover based on a KgNB security key of a gNB having a layer 1/layer 2 signaling-based handover configured therefor, the NCC value may not be changed because only a horizontal key is generated such that the KgNB* to be used in the target cell/target base station is continuously generated. In case that the UE performs a layer 1/layer 2 signaling-based handover, the AS security key to be used between the UE and target gNB is generated in the currently generated KgNB, and may be generated by using a common gNB security key count which is increased by 1 each time the UE performs a handover, or by using per-gNB security key count information with regard to each gNB that services each candidate cell.

(a) of FIG. 12 illustrates an embodiment in which a common gNB security key count is used. Referring to (a) of FIG. 12, the security key to be used in the target cell/target gNB may be generated by using a KgNB security key which is used in the UE's current serving cell/serving base station during AS security key generation, and a common gNB security key count which is increased by 1 or a predetermined number during a handover.

(b) of FIG. 12 illustrates an embodiment in which a per-gNB security key count is used. Referring to (b) of FIG. 12, the security key to be used in the target cell/target gNB to which the UE is to hand over is generated by using a KgNB security key which is used in the UE's current serving cell/serving base station during AS security key generation, and a per-gNB security key count which is managed in each candidate cell/candidate gNB. The per-gNB security key count may be increased by 1 or a predetermined number.

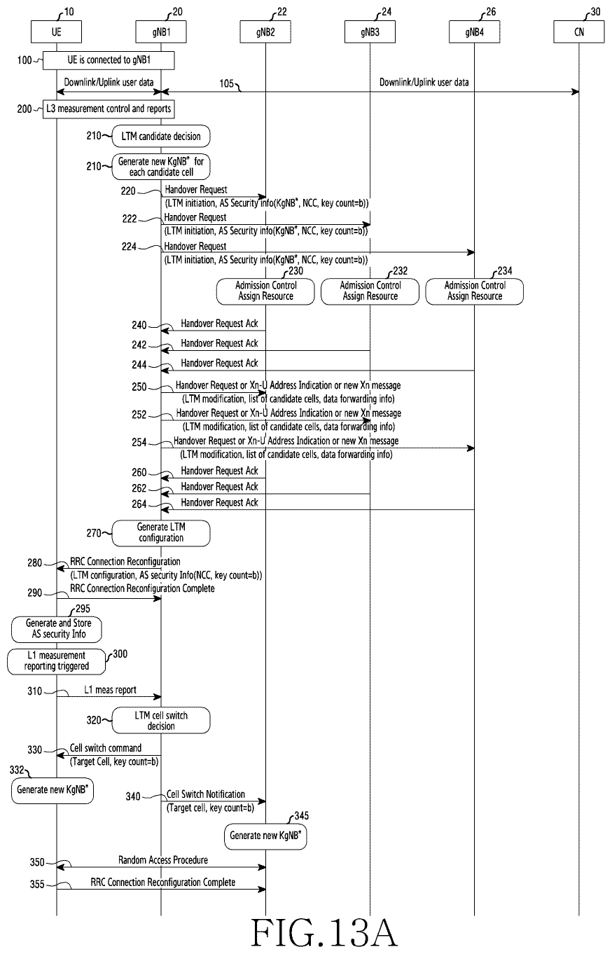

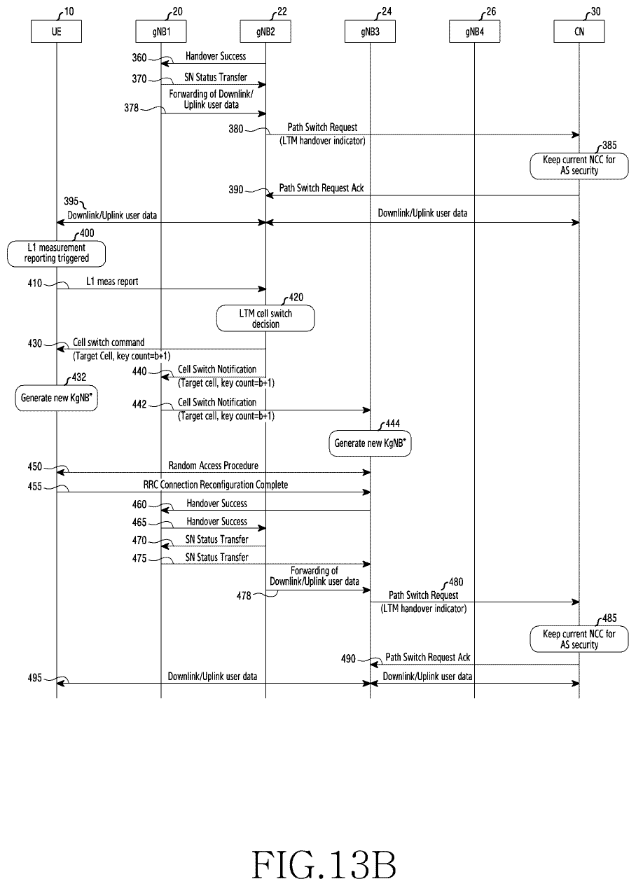

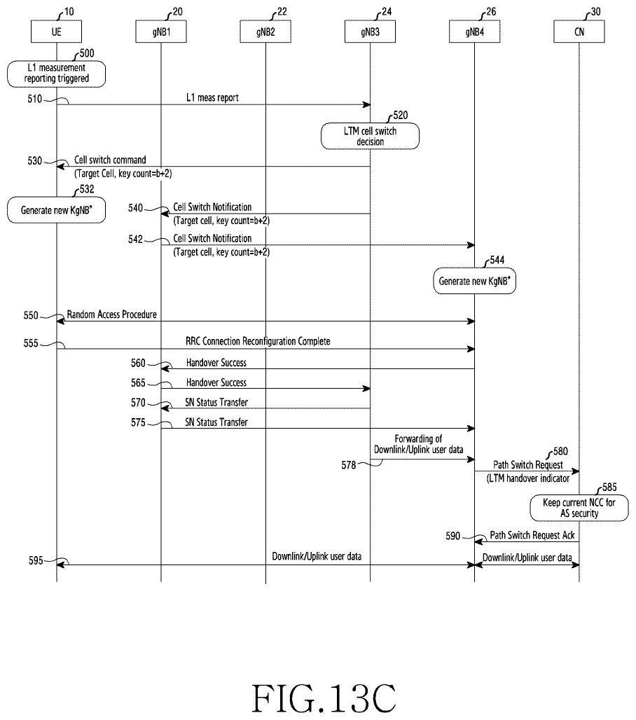

FIG. 13A, FIG. 13B, and FIG. 13C illustrate flowcharts for processes in which a UE, according to an embodiment of the disclosure, performs a continuous inter-base station handover based on layer 1/layer 2 signaling by using an AS security key generating method.

In connection with processes of transferring signal messages for the UE between base stations in FIG. 13A, FIG. 13B, and FIG. 13C, signal messages for the UE may be transferred between base stations through a base station for which a continuous inter-base station handover based on layer 1/layer 2 signaling is configured first.

Referring to FIG. 13A, the UE 10 may be connected to gNB1 20 (base station) in step 100, and may transmit/receive user packets through the gNB1 20 and 5GC 30 as in step 105. The UE 10 may perform layer 3 measurement, based on signals transmitted by base stations according to information configured by the gNB1 20, and may transfer measurement information to the gNB 20 in step 200.

Upon receiving the layer 3 measurement information from the UE 10 in step 200, the gNB 20 may determine whether or not to perform a configuration for performing a layer 1/layer 2 signaling-based handover for the UE 10 in step 210, and may determine to perform a layer 1/layer 2 signaling-based handover. In addition, the gNB 20 may determine the target cell to which the UE may hand over and gNBs including the target cell. In step 215, the gNB1 20 may generate a KgNB* security key which is to be used in each candidate cell to which the UE 10 may hand over, by using a KgNB security key which is currently used for security or an NH security key in case that there is an NH security key which has been received from the AMF and then stored therein. In connection with the KgNB* security key generated in step 215, each candidate cell's PCI and DL frequency information may differ, and a different KgNB* security key may accordingly be generated for each candidate cell.

The gNB1 20 may transmit handover request messages for configuring a layer 1/layer 2 signaling-based handover to gNBs determined in step 210, particularly to the gNB2 22, the gNB3 24, and the gNB4 26, respectively, in steps 220, 222, and 224. The handover request messages may include an indicator such as L1/L2 triggered mobility (LTM) initiation indicating that a handover is to be configured based on layer 1/layer 2 signaling, AS security information, information for LTM configurations, and the like. The AS security information may include NCC information associated with a KgNB* security key to be used for security in each candidate cell/candidate gNB, and may also include common security key count information in case that a common security key count is used. Upon receiving the handover request messages, the gNB2 22, the gNB3 24, and the gNB4 26 may determine whether or not to accept layer 1/layer 2 signaling-based handover configurations in steps 230, 232, and 234, respectively, may specify handover-related resources in case of determining to accept the same, and may transmit handover request acknowledge messages to the gNB1 20 in step 240, 242, and 244, respectively.

Upon receiving acknowledge messages from all gNBs to which handover request messages have been transmitted in step 240, 242, and 244, the gNB1 20 may transmit messages including information regarding candidate cells to which the UE may move, information regarding candidate gNBs, and information regarding data forwarding in respective base stations, which is to be used for inter-base station data forwarding during the UE's handover, to the gNB2 22, the gNB3 24, and the gNB4 26 in steps 250, 252, and 254, respectively. The messages transmitted from the gNB1 20 to the gNB2 22, the gNB3 24, and the gNB4 26 in steps 250, 252, and 254 may include indicators such as LTM modification in handover request messages, or Xn-U address indication messages or new messages may be defined and used. In case that handover request messages are used in steps 250, 252, and 254, the gNB2 22, the gNB3 24, and the gNB4 26 may transmit handover request acknowledge messages to the gNB1 20 in step 260, 262, and 264, respectively.

The gNB1 20 generates layer 1/layer 2 signaling-based handover configuration information (LTM configuration) to be transmitted to the UE, based on acknowledge messages received from the gNB2 22, the gNB3 24, and the gNB4 26, respectively, in step 270.

The gNB1 20 transmits layer 1/layer 2 signaling-based handover configuration information to the UE 10 by using an RRC message (for example, RRCConnectionReconfiguration message) in step 280. The UE 10 may transmit an RRC message (for example, RRCConnectionReconfigurationComplete) to the gNB1 20 as a response in step 290. The RRC message (for example, RRCConnectionReconfiguration message) that the UE 10 has received from the gNB1 20 in step 280 may include each candidate cell-specific AS security information. In addition, the AS security information may include NCC information which may indicate security key information to be used during a handover to the corresponding candidate cell, and common security key count information in case that a common security key count is used.

In step 295, the UE 10 may use a KgNB security key associated with the NCC transferred with regard to each candidate cell, or may generate an NH security key and then generate a new KgNB* security key with regard to each candidate cell.

In step 300, the UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied, the UE 10 may transmit a layer 1 measurement report message to the gNB1 20 by using a medium access control (MAC) control element (CE) in step 310. In steps 300 and 310, the UE 10 may measure layer 3 measurement information, report the same, and operate accordingly, instead of layer 1 measurement information, according to base station configurations. The gNB1 20 may determine whether or not to instruct the UE 10 to perform a layer 1/layer 2 signaling-based handover, based on the measurement report information received from the UE 10, in step 320. Upon determining to instruct a handover, the gNB1 20 may transmit a cell switch command message by using a MAC CE in step 330. The cell switch command message may include information regarding the target cell to which the UE 10 is to hand over, and AS security information. The AS security information included in the cell switch command message may include common security key count information in case that a common security key count is used. Instead of generating and storing an AS security key in step 295, the UE 10 may generate a KgNB security key to be used in the target cell in step 332. In case that the cell switch command message received in step 330 includes no AS security information, the KgNB security key in the target cell may be generated by using security key count information stored in the UE 10.

Upon determining whether or not to instruct the UE 10 to perform a layer 1/layer 2 signaling-based handover in step 320, the gNB1 20 may transmit a cell switch notification message to the gNB2 22 that is servicing the target cell to which the UE is to hand over in step 340. The cell switch notification message may include information regarding the target cell to which the UE is to hand over, AS security information, and other information regarding layer 1/layer 2 signaling-based handovers. The AS security information included in the cell switch notification message may include common security key count information in case that a common security key count is used.

Upon receiving the cell switch notification message from the gNB1 20 in step 340, the gNB2 22 may generate a KgNB security key to be used with the UE 10 in the gNB2 22 by using the KgNB* security key received from the gNB1 20 in step 220, the security key count, and the like. In case that a common security key count is used, the common security key count information included in the cell switch notification message may be used as the security key count value. In case that a per-gNB security key count is used, the security key count value managed by the gNB2 22 may be used to generate the KgNB security key.

Upon being instructed to perform a layer 1/layer 2 signaling-based handover in step 330, the UE 10 perform a procedure of random access to the target cell in step 350. Upon succeeding in the random access, the UE 10 may transmit an RRC message (for example, RRCConnectionReconfigurationComplete) to the gNB2 22 in step 355.

FIG. 13B illustrates a flowchart of a UE for performing a continuous inter-base station handover based on layer 1/layer 2 signaling by using an AS security key generating method according to an embodiment of the disclosure. FIG. 13B may illustrate operations which may be performed successively after the operations in FIG. 13A.

Referring to FIG. 13B, upon receiving an RRC message (for example, RRCConnectionReconfigurationComplete) from the UE 10, the gNB2 22 may transmit a handover success message to the gNB1 20 in step 360, thereby informing that the UE 10 has completed a layer 1/layer 2 signaling-based handover to the gNB2 22. In case that data forwarding from the gNB1 20 to the gNB2 22 is necessary, the gNB1 20 may transmit an SN status transfer message including PDCP sequence information which is necessary for data forwarding and the like to the gNB2 22 in step 370, and the gNB1 20 may forward data to the gNB2 22 in step 378.

The gNB2 22 may transmit a path switch request message to the 5GC 30 to inform that the UE 10 has handed over to the gNB2 22 in step 380. The 5GC 30 may transmit a path switch request acknowledge message to the gNB2 22 as a response in step 390. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy. In step 385, the 5GC 30 (the 5GC's AMF) may not increase the NCC value used for AS security of the UE and the base station, and may not generate a new NH security key. The path switch request acknowledge message transmitted from the 5GC 30 to the gNB2 22 in step 390 may include no security context information transmitted to the base station, or may include dummy information. In case that the path switch request acknowledge message includes security context information, the gNB2 22 does not use corresponding information.

In case that the UE 10 completes the handover procedure by performing the procedure in steps 380 and 390, the UE 10 may be connected to the gNB2 22 (base station) so as to transmit/receive user packets through the gNB2 22 and 5GC 30 as in step 395.

The UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 400, the UE 10 may transmit a layer 1 measurement report message to the gNB2 22 by using a medium access control (MAC) control element (CE) in step 410. In steps 400 and 410, the UE 10 may measure layer 3 measurement information, report the same, and operate accordingly, instead of layer 1 measurement information, according to base station configurations. The gNB2 22 may determine whether or not to instruct the UE 10 to perform a layer 1/layer 2 signaling-based handover, based on the measurement report information received from the UE 10, in step 420. Upon determining to instruct a handover, the gNB2 22 may transmit a cell switch command message by using a MAC CE in step 430. The cell switch command message may include information regarding the target cell to which the UE 10 is to hand over, and AS security information. The AS security information included in the cell switch notification message may include common security key count information in case that a common security key count is used. The UE 10 may generate a KgNB security key in the target cell, by using the common security key count information included in the cell switch notification message, or by using security key count information managed by the UE 10 for per-gNB security key count use, in step 432.

Upon determining whether or not to instruct the UE 10 to perform a layer 1/layer 2 signaling-based handover in step 420, the gNB2 22 may transmit a cell switch notification message to the gNB3 24 that is servicing the target cell to which the UE is to hand over in step 440. To this end, the gNB2 22 may transmit the cell switch notification message to the gNB1 20 in step 440, and the gNB1 20 may transmit the cell switch notification message to the gNB3 24 in step 442. The cell switch notification message may include information regarding the target cell to which the UE is to hand over, AS security information, and other information regarding layer 1/layer 2 signaling-based handovers. The gNB1 20 thus determines the gNB to which the cell switch notification message is to be transmitted from the gNB1 20, based on the target cell information included in the cell switch notification message. The AS security information included in the cell switch notification message may include common security key count information in case that a common security key count is used. In case that direct communication between candidate base stations is possible as in the embodiment in FIG. 4, the gNB2 22 may transmit no cell switch notification message to the gNB1 20 in step 440, and may transmit the cell switch notification message directly to the gNB3 24. In this case, step 445 may be omitted.

Upon receiving the cell switch notification message from the gNB1 20 in step 442, the gNB3 24 may generate a KgNB security key to be used in the gNB3 24 and the UE 10 in step 444 by using the KgNB* security key, security key count, and the like received from the gNB1 20 in step 222. In case that a common security key count is used, the common security key count information included in the cell switch notification message may be used as the security key count value. In case that a per-gNB security key count is used, the security key count value managed by the gNB3 24 may be used to generate the KgNB security key.

Upon being instructed to perform a layer 1/layer 2 signaling-based handover in step 430, the UE 10 performs a procedure of random access to the target cell in step 450. Upon succeeding in the random access, the UE 10 transmits an RRC message (for example, RRCConnectionReconfigurationComplete) to the gNB3 24 in step 455. Upon receiving the RRC message (for example, RRCConnectionReconfigurationComplete) from the UE 10, the gNB3 24 may transmit a handover success message to the gNB1 20 in step 460. The gNB1 20 may again transmit the handover success message to the gNB2 22 in step 465 to inform that the UE 10 has completed the layer 1/layer 2 signaling-based handover from the gNB2 22 to the gNB3 24. In case that data forwarding from the gNB2 22 to the gNB3 24 is necessary, the gNB2 22 may transmit an SN status transfer message including PDCP sequence information which is necessary for data forwarding and the like to the gNB1 20 in step 470. The gNB1 20 transmits the SN status transfer message to the gNB3 24 in step 470. The gNB2 22 forwards data to the gNB3 24 in step 478.

The gNB3 24 may transmit a path switch request message to the 5GC 30 to inform that the UE 10 has handed over to the gNB3 24 in step 480. The 5GC 30 may transmit a path switch request acknowledge message to the gNB3 24 as a response in step 490. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy. In step 485, the 5GC 30 (the 5GC's AMF) may not increase the NCC value used for AS security of the UE and the base station, and may not generate a new NH security key. The path switch request acknowledge message transmitted from the 5GC 30 to the gNB3 24 in step 490 may include no security context information transmitted to the base station, or may include dummy information. In case that the path switch request acknowledge message includes security context information, the gNB3 24 may not use corresponding information.

In case that the UE 10 completes the handover procedure by performing the procedure in steps 480 and 490, the UE 10 may be connected to the gNB3 24 (base station) so as to transmit/receive user packets through the gNB3 24 and 5GC 30 as in step 495.

FIG. 13C illustrates a flowchart of a UE, according to an embodiment of the disclosure, for performing a continuous inter-base station handover based on layer 1/layer 2 signaling by using an AS security key generating method. FIG. 13C may illustrate operations which may be performed successively after the operations in FIG. 13B.

Referring to FIG. 13C, the UE 10 may perform layer 1 measurement based on signals transmitted by base stations according to the layer 1/layer 2 signaling-based handover configuration information (LTM configuration) received from the gNB1 20. In case that the layer 1 measurement information reporting condition is satisfied in step 500, the UE 10 may transmit a layer 1 measurement report message to the gNB3 24 by using a medium access control (MAC) control element (CE) in step 510. In steps 500 and 510, the UE 10 may measure layer 3 measurement information, report the same, and operate accordingly, instead of layer 1 measurement information, according to base station configurations. The gNB3 24 may determine whether or not to instruct the UE 10 to perform a layer 1/layer 2 signaling-based handover, based on the measurement report information received from the UE 10, in step 520. Upon determining to instruct a handover, the gNB3 24 may transmit a cell switch command message by using a MAC CE in step 530. The cell switch command message may include information regarding the target cell to which the UE 10 is to hand over, and AS security information. The AS security information included in the cell switch command message may include common security key count information in case that a common security key count is used. The UE 10 may generate a KgNB security key in the target cell, by using the common security key count information included in the cell switch command message, or by using security key count information managed by the UE 10 for per-gNB security key count use, in step 532.

Upon determining whether or not to instruct the UE 10 to perform a layer 1/layer 2 signaling-based handover in step 520, the gNB3 24 may transmit a cell switch notification message to the gNB4 26 that is servicing the target cell to which the UE is to hand over in step 540. To this end, the gNB3 24 may transmit the cell switch notification message to the gNB1 20 in step 540, and the gNB1 20 may transmit the cell switch notification message to the gNB4 26 in step 542. The cell switch notification message may include information regarding the target cell to which the UE is to hand over, AS security information, and other information regarding layer 1/layer 2 signaling-based handovers. The gNB1 20 thus determines the gNB to which the cell switch notification message is to be transmitted from the gNB1 20, based on the target cell information included in the cell switch notification message. The AS security information included in the cell switch notification message may include common security key count information in case that a common security key count is used. In case that direct communication between candidate base stations is possible as in the embodiment in FIG. 4, the gNB3 24 may transmit no cell switch notification message to the gNB1 20 in step 540, and may transmit the cell switch notification message directly to the gNB4 26. In this case, step 442 may be omitted.

Upon receiving the cell switch notification message from the gNB1 20 in step 542, the gNB4 26 may generate a KgNB security key to be used in the gNB4 26 and the UE 10 in step 544 by using the KgNB* security key, security key count, and the like received from the gNB1 20 in step 222. In case that a common security key count is used, the common security key count information included in the cell switch notification message may be used as the security key count value. In case that a per-gNB security key count is used, the security key count value managed by the gNB4 26 may be used to generate the KgNB security key.

Upon being instructed to perform a layer 1/layer 2 signaling-based handover in step 530, the UE 10 perform a procedure of random access to the target cell in step 550. Upon succeeding in the random access, the UE 10 may transmit an RRC message (for example, RRCConnectionReconfigurationComplete) to the gNB4 26 in step 555. Upon receiving the RRC message (for example, RRCConnectionReconfigurationComplete) from the UE 10, the gNB4 26 may transmit a handover success message to the gNB1 20 in step 560.

The gNB1 20 may again transmit the handover success message to the gNB3 24 in step 565 to inform that the UE 10 has completed the layer 1/layer 2 signaling-based handover from the gNB3 24 to the gNB4 26. In case that data forwarding from the gNB3 24 to the gNB4 26 is necessary, the gNB3 24 may transmit an SN status transfer message including PDCP sequence information which is necessary for data forwarding and the like to the gNB1 20 in step 570.

The gNB1 20 may transmit the SN status transfer message to the gNB4 26 in step 575. The gNB3 24 may forward data to the gNB4 26 in step 578.

The gNB4 26 may transmit a path switch request message to the 5GC 30 to inform that the UE 10 has handed over to the gNB4 26 in step 580. The 5GC 30 may transmit a path switch request acknowledge message to the gNB4 26 as a response in step 590. The path switch request message may include an indicator such as an LTM handover indicator which indicates that the UE has performed a layer 1/layer 2 signaling-based handover. Upon receiving the LTM handover indicator, the 5GC 30 (the 5GC's AMF) may perform necessary operations, such as configuring the UE's policy.

In step 585, the 5GC 30 (the 5GC's AMF) may not increase the NCC value used for AS security of the UE and the base station, and may not generate a new NH security key. The path switch request acknowledge message transmitted from the 5GC 30 to the gNB4 26 in step 590 may include no security context information transmitted to the base station, or may include dummy information. In case that the path switch request acknowledge message includes security context information, the gNB4 26 may not use corresponding information.

In case that the UE 10 completes the handover procedure by performing the procedure in steps 580 and 590, the UE 10 may be connected to the gNB4 26 (base station) so as to transmit/receive user packets through the gNB4 26 and 5GC 30 in step 595.

According to an embodiment of the disclosure, [Table 1] to [Table 3] illustrate examples of the configuration of a handover request message transmitted through an inter-base station interface (for example, Xn interface), which may be used in steps 220, 222, 224, 250, 252, and 254 in FIG. 2A, FIG. 4, FIG. 7A, FIG. 11A, and FIG. 13A, and steps 320 and 325 in FIG. 3C, and some information elements (IEs) included in the message. This message may include, in addition to information included in the legacy Xn handover request message, additional information for the UE to support an inter-base station handover based on layer 1/layer 2 signaling, and additional information for supporting a continuous inter-base station handover based on layer 1/layer 2 signaling. Message names and IE names included in [Table 1] to [Table 3] are examples, and may be used with different names having identical functions.

[Table 1] shows a handover request message configuration example. This message includes pieces of legacy information necessary for a handover, such as a message type IE used to identify the message type, a source NG-RAN node UE XnAP ID reference IE which is an identifier used to identify the UE in the source gNB that transmits the message, a cause IE including information regarding the reason of message transmission in connection with the handover, a target cell global ID IE including information of the target cell to which a handover is to be performed, and the like. The message also includes UE context information, and includes a UE security capabilities IE including the UE's security support capability information, among the same, and an AS security information IE containing security information to be used in the target cell. The AS security information IE may be configured as in [Table 2], and may include a next hop chain count (NCC) value associated with KgNB* security key information to be used in a ciphering-related key information cell to be used in the target cell.

### [Table 1]

### A.1 Handover Request

This message is sent by the source NG-RAN node to the target NG-RAN node to request the preparation of resources for a handover.

Direction: source NG-RAN node→target NG-RAN node.

| IE/Group | | | IE type and | | | Assigned |
|---|---|---|---|---|---|---|
| Name | Presence | Range | reference | Semantics description | Criticality | Criticality |
| Message | M | | Message | The Message Type IE | YES | reject |
| Type | | | Type IE | uniquely identifies | | |
| | | | | the message being sent. | | |
| Source | M | | NG-RAN | The NG-RAN node UE | YES | reject |
| NG-RAN | | | node UE | XnAP ID uniquely | | |
| node UE | | | XnAP ID | identifies a UE over | | |
| XnAP ID | | | IE | the Xn interface | | |
| reference | | | | within the NG-RAN node. | | |
| | | | | Allocated at the | | |
| | | | | source NG-RAN node | | |
| Cause | M | | Cause IE | Indicate the reason | YES | reject |
| | | | | for a particular event | | |
| | | | | for the XnAP protocol | | |
| Target Cell | M | | Target Cell | Includes either an E- | YES | reject |
| Global ID | | | Global ID | UTRA CGI or an NR | | |
| | | | IE | CGI. This IE is used | | |
| | | | | to globally identify a | | |
| | | | | cell. | | |

[. . .]

| | | | |
|---|---|---|---|
| UE Context | 1 | YES | reject |
| Information | | | |

[. . .]

| | | | | |
|---|---|---|---|---|
| >UE | M | UE | The UE Security | — |
| Security | | Security | Capabilities IE defines | |
| Capabilities | | Capabilities | the supported | |
| | | IE | algorithms for | |
| | | | encryption and | |
| | | | integrity protection | |
| | | | in the UE | |
| >AS | M | AS | The AS Security | — |
| Security | | Security | Information IE is | |
| Information | | Information | used to generate the | |
| | | IE A.2 | key material (Key | |
| | | | NG-RAN Star and | |
| | | | Next Hop Chaining | |
| | | | Count) to be used for | |
| | | | AS security with the | |
| | | | UE. | |

[. . .]

| | | | | | | |
|---|---|---|---|---|---|---|
| LTM | O | | | | YES | reject |
| Handover | | | | | | |
| Information | | | | | | |
| >LTM | M | | ENUMERATED | | — | |
| Trigger | | | (LTM- | | | |
| | | | initiation, | | | |
| | | | LTM- | | | |
| | | | modification, | | | |
| | | | . . .) | | | |
| >Target | C-ifLTM | | NG-RAN node | The NG-RAN node UE | | |
| NG-RAN node | mod | | UE XnAP ID IE | XnAP ID uniquely | | |
| UE XnAP ID | | | | identifies a UE | | |
| | | | | over the Xn interface | | |
| | | | | within the NG-RAN node. | | |
| | | | | Allocated at the | | |
| | | | | target NG-RAN node | | |
| >LTM | O | | INTEGER | Corresponds to the | | |
| Configuration | | | (1 . . . 8) | LTM-CandidateId IE as | | |
| ID | | | | defined in TS 38.331. | | |
| >Reference | O | | Reference | This IE contains the | | |
| Configuration | | | Configuration | reference configuration | | |
| | | | IE | used for LTM. | | |
| >CSI | O | | OCTET STRING | Includes the ltm-CSI- | | |
| Resource | | | | ResourceConfigToAddModList | | |
| Configuration | | | | IE as defined in TS 38.331. | | |
| > LTM | O | | LTM | This IE indicates the | | |
| Configuration | | | Configuration | list of LTM cells | | |
| ID Mapping | | | ID Mapping | associated with its | | |
| List | | | List IE A.3 | configuration IDs | | |
| >Xn-U | | 0 . . . | | | — | |
| Address | | <maxnoofPDUSessions> | | | | |
| Information | | | | | | |
| per PDU | | | | | | |
| Session | | | | | | |
| Resources | | | | | | |
| Item | | | | | | |
| >>PDU | M | | PDU Session | This IE identifies a | — | |
| Session ID | | | ID IE | PDU Session for a UE. | | |
| | | | | Definition and use of | | |
| | | | | the PDU Session ID | | |
| >>Data | O | | Data | This IE contains | — | |
| Forwarding | | | Forwarding | TNL information for | | |
| Info from | | | Info from | the establishment of | | |
| target NG- | | | target NG- | data forwarding | | |
| RAN node | | | RAN node IE | tunnels towards the | | |
| | | | | target NG-RAN node. | | |
| >>Secondary | O | | Secondary | This IE may be | YES | ignore |
| Data | | | Data | present only when | | |
| Forwarding | | | Forwarding | the target M-NG- | | |
| Info from | | | Info from | RAN node decide to | | |
| target NG- | | | target NG- | split a PDU session | | |
| RAN node | | | RAN node | between MN and SN | | |
| List | | | List IE | | | |

### [Table 2]

### A.2 AS Security Information

The AS Security Information IE is used to generate the key material to be used for AS security with the UE.

| | | | | |
|---|---|---|---|---|
| IE/Group | | | IE Type and | Semantics |
| Name | Presence | Range | Reference | Description |

| | | | |
|---|---|---|---|
| Key NG-RAN | M | BIT STRING | K_{NG-RAN}* |
| Star | | (256) | defined in TS |
| | | | 33.501. |
| Next Hop | M | INTEGER | Next Hop |
| Chaining | | (0 . . . 7) | Chaining Count |
| Count | | | (NCC) defined |
| | | | in TS 33.501 |

The handover request message in [Table 1] may include an LTM handover information IE including information for supporting a layer 1/layer 2 signaling-based handover, in addition thereto. The LTM handover information IE may include an LTM trigger IE which may include information indicating that a layer 1/layer 2 signaling-based handover is started (“LTM-initiation”), or a message is transmitted to modify already-configured layer 1/layer 2 signaling-based handover-related information (“LTM-modification”). In case that a message is transmitted to modify already-configured layer 1/layer 2 signaling-based handover-related information (“LTM-modification”), target NG-RAN node UE XnAP ID IE information is included, which is a UE identifier for identifying the UE in the target cell/target gNB. The LTM handover information IE may include an LTM configuration ID IE including an identifier for identifying layer 1/layer 2 signaling-based handover-related information, and may include a reference configuration IE including layer 1/layer 2 signaling-based handover-related reference information, and a channel state information (CSI) resource configuration IE including layer 1/layer 2 signaling-based handover-related CSI resource information which needs to be added or modified. The LTM handover information IE may include an LTM configuration ID mapping list IE including information of the list of information of cells to which a layer 1/layer 2 signaling-based handover is to be performed, which is associated with LTM configuration ID information. The LTM configuration ID mapping list IE may be configured as in [Table 3]. The LTM configuration ID mapping list IE may include an LTM cell ID IE including information of cells to which a layer 1/layer 2 signaling-based handover is to be performed, and an LTM configuration ID IE including an identifier for identifying associated layer 1/layer 2 signaling-based handover-related information.

### [Table 3]

### A.3 LTM Configuration ID Mapping List

This IE indicates the list of LTM cells associated with its configuration IDs.

| | | | IE type and | Semantics | | Assigned |
|---|---|---|---|---|---|---|
| IE/Group Name | Presence | Range | reference | description | Criticality | Criticality |
| Configuration | | 1 . . . | | | — | — |
| ID Mapping | | <maxnoofLTMCells> | | | | |
| Item IEs | | | | | | |
| >LTM Cell ID | M | | Target Cell | This IE is used | — | |
| | | | Global ID | to globally | | |
| | | | IE | identify a cell. | | |
| >LTM | O | | INTEGER | Corresponds to | — | |
| Configuration | | | (1 . . . 8) | the LTM- | | |
| ID | | | | CandidateId IE | | |
| >Candidate NG- | O | | NG-RAN node | The NG-RAN | | |
| RAN node UE | | | UE XnAP ID | node UE XnAP | | |
| XnAP ID | | | IE | ID uniquely | | |
| reference | | | | identifies a UE | | |
| | | | | over the Xn | | |
| | | | | interface | | |
| | | | | within the NG- | | |
| | | | | RAN node. | | |
| | | | | Allocated at | | |
| | | | | the candidate | | |
| | | | | NG-RAN node | | |
| | | | | serving Target | | |
| | | | | Cell | | |
| >LTM UE | | | INTEGER | This IE is used | | |
| Reference ID | | | (1 . . . 65535) | to uniquely | | |
| | | | | identify a UE | | |
| | | | | in the candidate | | |
| | | | | LTM cell. | | |

In addition, the LTM configuration ID mapping list IE may include candidate NG-RAN node UE XnAP ID reference IE information which is identifier information for identifying the UE in each candidate gNB in order to support direct communication between candidate gNBs, or an LTM UE reference ID IE including separate UE identifier information.

The LTM handover information IE may include an Xn-U address information per PDU session resources item IE which may be used in case of supporting data forwarding in a process in which a layer 1/layer 2 signaling-based handover is performed. The Xn-U address information per PDU session resources item IE may include a PDU session ID IE which is PDU session-specific PDU session identifier information, a data forwarding info from target NG-RAN node IE including data forwarding-related transport network layer (TNL) information and the like, and a secondary data forwarding info from target NG-RAN node list IE including additional data forwarding-related transport network layer (TNL) information and the like in case that a split PDU session is used for a dual connection.

According to an embodiment of the disclosure, [Table 4] illustrates an example of the configuration of an Xn-U address indication message transmitted through an inter-base station interface (for example, Xn interface), which may be used in steps 250, 252, and 254 in FIG. 2A, FIG. 4A, FIG. 7A, FIG. 11A, and FIG. 13A, and steps 320 and 325 in FIG. 3C, and some information elements (IEs) included in the message. In addition, some information elements (IEs) included in the Xn-U address indication message in [Table 4] may also be included in an LTE configuration update message which may be used in steps 262, 264, and 266 in FIG. 8A, or other new message. This message may include, in addition to information included in the legacy Xn-U address indication message, additional information for the UE to support an inter-base station handover based on layer 1/layer 2 signaling, and additional information for supporting a continuous inter-base station handover based on layer 1/layer 2 signaling. Message names and IE names included in [Table 4] are examples, and may be used with different names having identical functions.

### [Table 4]

### B.1 XN-U Address Indication

This message is either sent by the new NG-RAN node to transfer data forwarding information to the old NG-RAN node, or by the M-NG-RAN node to provide either data forwarding or Xn-U bearer address related information for SN terminated bearers to the S-NG-RAN node.

Direction: new NG-RAN node→old NG-RAN node, M-NG-RAN node→S-NG-RAN node.

| | | | IE type and | | | Assigned |
|---|---|---|---|---|---|---|
| IE/Group Name | Presence | Range | reference | Semantics description | Criticality | Criticality |
| Message Type | M | | Message | The Message Type IE | YES | reject |
| | | | Type IE | uniquely identifies | | |
| | | | | the message being sent. | | |
| New NG-RAN | M | | NG-RAN | The NG-RAN node UE XnAP | YES | ignore |
| node UE XnAP | | | node UE | ID uniquely identifies | | |
| ID reference | | | XnAP ID | a UE over the Xn | | |
| | | | | interface within the | | |
| | | | | NG-RAN node. Allocated | | |
| | | | | at the new NG-RAN node | | |
| Old NG-RAN node | M | | NG-RAN | The NG-RAN node UE XnAP | YES | ignore |
| UE XnAP ID | | | node UE | ID uniquely identifies | | |
| reference | | | XnAP ID | a UE over the Xn | | |
| | | | | interface within the | | |
| | | | | NG-RAN node. | | |
| | | | | Allocated at the old | | |
| | | | | NG-RAN node | | |
| Xn-U Address | | 1 | | | YES | reject |
| Information per | | | | | | |
| PDU Session | | | | | | |
| Resources List | | | | | | |
| >Xn-U Address | | 1 . . . | | | — | |
| Information per | | <maxnoofPDUSessions> | | | | |
| PDU Session | | | | | | |
| Resources Item | | | | | | |
| >>PDU Session ID | M | | PDU Session | This IE identifies a | — | |
| | | | ID IE | PDU Session for a UE. | | |
| | | | | Definition and use of | | |
| | | | | the PDU Session ID | | |
| >>Data | O | | Data | This IE contains TNL | — | |
| Forwarding Info | | | Forwarding | information for the | | |
| from target NG- | | | Info from | establishment of data | | |
| RAN node | | | target NG- | forwarding tunnels | | |
| | | | RAN node | towards the target | | |
| | | | IE | NG-RAN node. | | |
| >>Secondary Data | O | | Secondary | This IE may be present | YES | ignore |
| Forwarding Info | | | Data | only when the target | | |
| from target NG- | | | Forwarding | M-NG-RAN node decide | | |
| RAN node List | | | Info from | to split a PDU session | | |
| | | | target NG- | between MN and SN | | |
| | | | RAN node | | | |
| | | | List IE | | | |

[ . . . ]

| | | | | | |
|---|---|---|---|---|---|
| LTM Handover | O | | | YES | reject |
| Information | | | | | |
| >LTM Trigger | O | ENUMERATED | | — | |
| | | (LTM- | | | |
| | | initiation, | | | |
| | | LTM- | | | |
| | | modification, | | | |
| | | . . . ) | | | |
| >Target NG-RAN | C- | NG-RAN node | The NG-RAN node UE XnAP | | |
| node UE XnAP ID | ifLTMmod | UE XnAP ID | ID uniquely identifies | | |
| | | IE | a UE over the Xn | | |
| | | | interface within the | | |
| | | | NG-RAN node. Allocated | | |
| | | | at the target NG-RAN | | |
| | | | node | | |
| >LTM | O | INTEGER | Corresponds to the LTM- | | |
| Configuration | | (1 . . . 8) | CandidateId IE | | |
| ID | | | | | |
| >Reference | O | Reference | This IE contains the | | |
| Configuration | | Configuration | reference configuration | | |
| | | IE | used for LTM. | | |
| >CSI Resource | O | OCTET | Includes the ltm-CSI- | | |
| Configuration | | STRING | ResourceConfigToAddModList | | |
| | | | IE | | |
| >LTM | O | LTM | This IE indicates the | | |
| Configuration | | Configuration | list of LTM cells | | |
| ID Mapping | | ID Mapping | associated with its | | |
| List | | List IE A.3 | configuration IDs | | |

The Xn-U address indication message in [Table 4] may include pieces of legacy information necessary for a handover, such as a message type IE used to identify the message type, a new NG-RAN node UE XnAP ID reference IE which is an identifier used to identify the UE in the new gNB that transmits the message, an old NG-RAN node UE XnAP ID reference IE which is an identifier used to identify the UE in the old gNB that receives the message, and the like.

The Xn-U address indication message may include an Xn-U address information per PDU session resources list IE. The Xn-U address information per PDU session resources list IE in the message may include a PDU session ID IE which is PDU session-specific PDU session identifier information, a data forwarding info from target NG-RAN node IE including data forwarding-related transport network layer (TNL) information and the like, and a secondary data forwarding info from target NG-RAN node list IE including additional data forwarding-related transport network layer (TNL) information and the like in case that a split PDU session is used for a dual connection.

The Xn-U address indication message may additionally include an LTM handover information IE including information for supporting a layer 1/layer 2 signaling-based handover. The LTM handover information IE may include an LTM trigger IE which may include information indicating that a layer 1/layer 2 signaling-based handover is started (“LTM-initiation”), or a message is transmitted to modify already-configured layer 1/layer 2 signaling-based handover-related information (“LTM-modification”). In case that a message is transmitted to modify already-configured layer 1/layer 2 signaling-based handover-related information (“LTM-modification”), target NG-RAN node UE XnAP ID IE information may be included, which is a UE identifier for identifying the UE in the target cell/target gNB. The LTM handover information IE may include an LTM configuration ID IE including an identifier for identifying layer 1/layer 2 signaling-based handover-related information, and may include a reference configuration IE including layer 1/layer 2 signaling-based handover-related reference information, and a channel state information (CSI) resource configuration IE including layer 1/layer 2 signaling-based handover-related CSI resource information which may be added or modified. The LTM handover information IE may include an LTM configuration ID mapping list IE including information of the list of information of cells to which a layer 1/layer 2 signaling-based handover is to be performed, which is associated with LTM configuration ID information. The LTM configuration ID mapping list IE may be configured as in [Table 4] described above. The LTM configuration ID mapping list IE may include an LTM cell ID IE including information of cells to which a layer 1/layer 2 signaling-based handover is to be performed, and an LTM configuration ID IE including an identifier for identifying associated layer 1/layer 2 signaling-based handover-related information. In addition, the LTM configuration ID mapping list IE may include candidate NG-RAN node UE XnAP ID reference IE information which is identifier information for identifying the UE in each candidate gNB in order to support direct communication between candidate gNBs, or an LTM UE reference ID IE including separate UE identifier information.

[Table 5] illustrates an example of the configuration of a handover request acknowledge message transmitted through an inter-base station interface (for example, Xn interface), which may be used in steps 240, 242, 244, 260, 262, and 264 in FIG. 2A, FIG. 4A, FIG. 7A, FIG. 11A, and FIG. 13A, and steps 330 and 335 in FIG. 3C, and some information elements (IEs) included in the message. This message may include, in addition to information included in the legacy Xn handover request acknowledge message, additional information for the UE to support an inter-base station handover based on layer 1/layer 2 signaling, and additional information for supporting a continuous inter-base station handover based on layer 1/layer 2 signaling. Message names and IE names included in [Table 5] are examples, and may be used with different names having identical functions.

The handover request acknowledge message in [Table 5] may include pieces of legacy information necessary for a handover, such as a message type IE used to identify the message type, a source NG-RAN node UE XnAP ID reference IE which is an identifier used to identify the UE in the source gNB that transmits the message, a target NG-RAN node UE XnAP ID reference IE which is an identifier used to identify the UE in the target gNB that receives the message, and the like. In addition, the message may include a target NG-RAN node to source NG-RAN node transparent container IE including an RRC HandoverCommand message to be transmitted to the UE.

### [Table 5]

### C.1 Handover Request Acknowledge

This message is sent by the target NG-RAN node to inform the source NG-RAN node about the prepared resources at the target.

Direction: target NG-RAN node→source NG-RAN node.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | Message | The Message | YES | reject |
| | | Type IE | Type IE | | |
| | | | uniquely | | |
| | | | identifies the | | |
| | | | message being | | |
| | | | sent. | | |
| Source NG-RAN | M | NG-RAN | The NG-RAN | YES | ignore |
| node UE XnAP ID | | node UE | node UE | | |
| | | XnAP ID | XnAP ID | | |
| | | | uniquely | | |
| | | | identifies a UE | | |
| | | | over the Xn | | |
| | | | interface | | |
| | | | within the NG- | | |
| | | | RAN node. | | |
| | | | Allocated at | | |
| | | | the source NG- | | |
| | | | RAN node | | |
| Target NG-RAN | M | NG-RAN | The NG-RAN | YES | ignore |
| node UE XnAP ID | | node UE | node UE | | |
| | | XnAP ID | XnAP ID | | |
| | | | uniquely | | |
| | | | identifies a UE | | |
| | | | over the Xn | | |
| | | | interface | | |
| | | | within the NG- | | |
| | | | RAN node. | | |
| | | | Allocated at | | |
| | | | the target NG- | | |
| | | | RAN node | | |

[ . . . ]

| | | | | | |
|---|---|---|---|---|---|
| Target NG-RAN | M | OCTET | Includes the | YES | ignore |
| node To Source | | STRING | HandoverCommand | | |
| NG-RAN node | | | message. | | |
| Transparent | | | | | |
| Container | | | | | |

[ . . . ]

| | | | | | | |
|---|---|---|---|---|---|---|
| LTM | | 0 . . . 1 | | | YES | ignore |
| Configuration | | | | | | |
| Acknowledge | | | | | | |
| >SSB Information | M | | | | — | |
| Item | | | | | | |
| >>SSB | M | | SSB Time/ | This IE | — | |
| Time/Frequency | | | Frequency | contains the | | |
| Configuration | | | Configuration | time and | | |
| | | | IE | frequency | | |
| | | | | configuration | | |
| | | | | of an SSB. | | |
| >>NR PCI | M | | INTEGER | Physical Cell | — | |
| | | | (0 . . . 1007) | ID | | |
| >LTM Reference | O | | OCTET | Includes the | — | |
| Configuration | | | STRING | CellGroupConfig | | |
| | | | | IE | | |
| >LTM Complete | O | | ENUMERATED | This IE | — | |
| Configuration | | | (complete, | indicates the | | |
| Indicator | | | . . . ) | LTM candidate | | |
| | | | | configuration | | |
| | | | | is a complete | | |
| | | | | configuration. | | |
| >LTM UE | | | INTEGER | This IE is used | | |
| Reference ID | | | (1 . . . 65535) | to uniquely | | |
| | | | | identify a UE | | |
| | | | | in the candidate | | |
| | | | | LTM cell. | | |

The handover request message in [Table 5] may additionally include an LTM configuration acknowledge IE including information for supporting an inter-base station handover based on layer 1/layer 2 signaling. The LTM configuration acknowledge IE may include an SSB information item IE including synchronization signal block (SSB) information. The SSB information item IE may include an SSB time/frequency configuration IE including SSB configuration information, and an NR PCI IE including the corresponding cell's physical cell identifier (PCI) information. In addition, the LTM configuration acknowledge IE may include an LTM reference configuration IL including CellGroupConfig information including layer 1/layer 2 signaling-based handover-related reference information.

[Table 6] and [Table 7] illustrate an example of the configuration of a cell switch notification message transmitted through an inter-base station interface (for example, Xn interface), which may be used in steps 340, 440, 445, 540, and 545 in FIG. 2A, FIG. 21B, FIG. 7A to FIG. 7C, FIG. 9, FIG. 11A to FIG. 11C, and FIG. 13A to FIG. 13C, and steps 340, 440, and 540 in FIG. 4A and FIG. 4B, and information elements (IEs) included in the message. Message names and IE names included in [Table 6] and [Table 7] are examples, and may be used with different names having identical functions.

The cell switch notification message in [Table 6] may include pieces of legacy information necessary for a handover, such as a message type IE used to identify the message type, a source NG-RAN node UE XnAP ID reference IE which is an identifier used to identify the UE in the source gNB that transmits the message, a target NG-RAN node UE XnAP ID reference IE which is an identifier used to identify the UE in the target gNB that receives the message, and the like. In addition, the message may include a cell ID IE including targe cell information, and an LTM cell switch information IE. The LTM cell switch information IE may include a TCI state ID IE including beam-related information by which the UE performs a layer 1/layer 2 signaling-based handover. The cell switch notification message may additionally include an AS security context IE including security-related information to be used in the target cell/target gNB.

The AS security context IE included in the cell switch notification message may be configured as in [Table 7], and may include a next hop chaining count IE including a next hop chain count (NCC) value associated with a next-hop NH IE which is security key information to be used in a ciphering-related key information cell to be used in the target cell, and may include a security key count IE in case of using a method of generating a security key based on a key count.

### [Table 6]

### D.1 Cell Switch Notification

Direction: source NG-RAN node→target NG-RAN node, source NG-RAN node→anchor NG-RAN node, anchor NG-RAN node→target NG-RAN node

| | | | IE type and | Semantics | | Assigned |
|---|---|---|---|---|---|---|
| IE/Group Name | Presence | Range | reference | description | Criticality | Criticality |
| Message Type | M | | Message | The Message | YES | ignore |
| | | | Type IE | Type IE | | |
| | | | | uniquely | | |
| | | | | identifies the | | |
| | | | | message being | | |
| | | | | sent. | | |
| Source NG-RAN | M | | NG-RAN | The NG-RAN | YES | ignore |
| node UE XnAP ID | | | node UE | node UE XnAP | | |
| | | | XnAP ID | ID uniquely | | |
| | | | | identifies a UE | | |
| | | | | over the Xn | | |
| | | | | interface | | |
| | | | | within the NG- | | |
| | | | | RAN node. | | |
| | | | | Allocated at | | |
| | | | | the source NG- | | |
| | | | | RAN node | | |
| Target NG-RAN | M | | NG-RAN | The NG-RAN | YES | ignore |
| node UE XnAP ID | | | node UE | node UE XnAP | | |
| | | | XnAP ID | ID uniquely | | |
| | | | | identifies a UE | | |
| | | | | over the Xn | | |
| | | | | interface | | |
| | | | | within the NG- | | |
| | | | | RAN node. | | |
| | | | | Allocated at | | |
| | | | | the target NG- | | |
| | | | | RAN node | | |
| Cell ID | M | | Target Cell | This IE is used | YES | reject |
| | | | Global ID IE | to globally | | |
| | | | | identify a cell. | | |
| LTM Cell Switch | | 0 . . . 1 | | | YES | ignore |
| Information | | | | | | |
| >TCI State ID | M | | INTEGER | Corresponds to | — | |
| | | | (0 . . . 127) | the CandidateTCI- | | |
| | | | | StatesId IE as | | |
| | | | | defined in TS | | |
| | | | | 38.331. | | |
| AS Security | O | | D.2 | | YES | reject |
| Context | | | | | | |

### [Table 7]

### D.2 AS Security Context

This IE provides security related parameters to the NG-RAN node which are used to derive security keys for user plane traffic and RRC signalling messages and for security parameter generation for subsequent mobility, see TS 33.501.

| | | | | |
|---|---|---|---|---|
| IE/Group | | | IE type and | |
| Name | Presence | Range | reference | Semantics description |

| | | | |
|---|---|---|---|
| Next Hop | O | INTEGER | Next Hop Chaining |
| Chaining | | (0 . . . 7) | Counter (NCC) |
| Count | | | defined in TS 33.501. |
| Next-Hop | O | Security | The NH together with |
| NH | | Key IE | the NCC is used to |
| | | | derive the security |
| | | | configuration as |
| | | | defined in TS 33.501. |
| Security | O | INTEGER | |
| Key Count | | (0 . . . 65535) | |

[Table 8] illustrates an example of the configuration of a path switch request message transmitted from a base station to a core network through an interface (for example, NG interface) between the base station and the core network, which may be used in steps 380, 480, and 580 in FIG. 2A, FIG. 2B, FIG. 4A, FIG. 4B, FIG. 7A to FIG. 7C, FIG. 9, FIG. 11A to FIG. 11C, and FIG. 13A to FIG. 13C, and some information elements (IEs) included in the message. Message names and IP names included in [Table 8] are examples, and may be used with different names having identical functions.

### [Table 8]

### E.1 Path Switch Request

This message is sent by the NG-RAN node to inform the A F of the new serving NG-RAN node and to transfer some NG-U DL tunnel termination point(s) to the SMF via the AMF for one or multiple PDU session resources.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | Message | The Message Type IE | YES | reject |
| | | Type IE | uniquely identifies | | |
| | | | the message being | | |
| | | | sent. | | |
| RAN UE NGAP ID | M | RAN UE | This IE uniquely | YES | reject |
| | | NGAP ID | identifies the UE | | |
| | | IE | association over the | | |
| | | | NG interface within | | |
| | | | the NG-RAN node. | | |
| Source AMF UE | M | AMF UE | This IE uniquely | YES | reject |
| NGAP ID | | NGAP ID | identifies the UE | | |
| | | IE | association over the | | |
| | | | NG interface | | |

[ . . . ]

| | | | |
|---|---|---|---|
| PDU Session | 1 | YES | reject |
| Resource to be | | | |
| Switched in | | | |
| Downlink List | | | |

[ . . . ]

| | | | |
|---|---|---|---|
| PDU Session | 0 . . . 1 | YES | ignore |
| Resource Failed | | | |
| to Setup List | | | |

[ . . . ]

| | | | | |
|---|---|---|---|---|
| LTM Handover | O | ENUMERATED | YES | ignore |
| Indication | | (true, . . . ) | | |

The path switch request message in [Table 8] may include pieces of legacy information necessary for transmission from a base station to a core network during a handover process, such as a message type IE used to identify the message type, a RAN UE NGAP ID IE which is an identifier used to identify the UE in the base station (gNB) that transmits the message, a source AMF UE NGAP ID IE which is an identifier used to identify the UE in the core network (for example, the AMF of the 5GC) that receives the message, a PDU session resource to be switched in downlink list IE including PDU session information indicating a successful handover to the target base station, and a PDU session resource failed to setup list IE including PDU session information indicating a handover to the target base station has failed and is released. In addition, the path switch request message may additionally include an LTM handover indication IE indicating that the UE has performed a layer 1/layer 2 signaling-based handover, in order to support an inter-base station handover based on layer 1/layer 2 signaling.

[Table 9] and [Table 10] illustrate an example of the configuration of a path switch request acknowledge message transmitted from a core network to a base station through an interface (for example, NG interface) between the base station and the core network, which may be used in steps 390, 490, and 590 in FIG. 2A, FIG. 2B, FIG. 4A, FIG. 4B, FIG. 7A to FIG. 7C, FIG. 9, FIG. 11A to FIG. 11C, and FIG. 13A to FIG. 13C, and some information elements (IEs) included in the message. Message names and IE names included in [Table 9] and [Table 10] are examples, and may be used with different names having identical functions.

The path switch request acknowledge message in [Table 9] may include pieces of legacy information necessary for transmission from a core network to a base station during a handover process, such as a message type IE used to identify the message type, an AMF UE NGAP ID IE which is an identifier used to identify the UE in the core network (for example, the AMF of the 5GC) that transmits the message, a RAN UE NGAP ID IE which is an identifier used to identify the UE in the base station (gNB) that receives the message, a PDU session resource switched list IE including PDU session information indicating a successful handover to the target base station, and a PDU session resource released list IE including PDU session information indicating a handover to the target base station has failed and is released.

In addition, the path switch request acknowledge message may include a security context IE which may be used by the base station to update security information with the UE. The security context IE may be configured as in [Table 10], and includes a next hop chaining count IE including a next hop chain count (NCC) value associated with a next-hop NH IE which is security key information to be used in ciphering-related key information to be used in the base station. The path switch request acknowledge message may additionally include a security context ignored IE including an indicator instructing to ignore security context information included in the security context IE transferred from the core network to the base station in case that the core network performs no operation of updating the security key for AS security during the UE's handover, according to the security method used by the base station during a continuous inter-base station handover based on layer 1/layer 2 signaling, in order to support a continuous inter-base station handover based on layer 1/layer 2 signaling.

### [Table 9]

### F.1 Path Switch Request Acknowledge

This message is sent by the AMF to inform the NG-RAN node that the path switch has been successfully completed in the 5GC.

Direction: AMF→NG-RAN node.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | Message | The Message | YES | reject |
| | | Type IE | Type IE | | |
| | | | uniquely | | |
| | | | identifies the | | |
| | | | message being | | |
| | | | sent. | | |
| AMF UE NGAP ID | M | RAN UE | This IE | YES | ignore |
| | | NGAP ID | uniquely | | |
| | | IE | identifies the | | |
| | | | UE association | | |
| | | | over the NG | | |
| | | | interface | | |
| | | | within the NG- | | |
| | | | RAN node. | | |
| RAN UE NGAP ID | M | AMF UE | This IE | YES | ignore |
| | | NGAP ID | uniquely | | |
| | | IE | identifies the | | |
| | | | UE association | | |
| | | | over the NG | | |
| | | | interface | | |

[ . . . ]

| | | | | |
|---|---|---|---|---|
| Security Context | M | F.2 | YES | reject |

[ . . . ]

| | | | |
|---|---|---|---|
| PDU Session | 1 | YES | ignore |
| Resource Switched | | | |
| List | | | |

[ . . . ]

| | | | |
|---|---|---|---|
| PDU Session | 0 . . . 1 | YES | ignore |
| Resource Released | | | |
| List | | | |

[ . . . ]

| | | | | |
|---|---|---|---|---|
| Security Context | O | ENUMERATED | YES | reject |
| Ignored | | (true, . . . ) | | |

### [Table 10]

### F.2 Security Context

This IE provides security related parameters to the NG-RAN node which are used to derive security keys for user plane traffic and RRC signalling messages and for security parameter generation for subsequent mobility, see TS 33.501.

| | | | | |
|---|---|---|---|---|
| IE/Group | | | IE type and | |
| Name | Presence | Range | reference | Semantics description |

| | | | |
|---|---|---|---|
| Next Hop | M | INTEGER | Next Hop Chaining |
| Chaining | | (0 . . . 7) | Counter (NCC) |
| Count | | | defined in TS 33.501. |
| Next-Hop | M | Security | The NH together with |
| NH | | Key IE | the NCC is used to |
| | | | derive the security |
| | | | configuration as |
| | | | defined in TS 33.501. |

[Table 11] and [Table 12] illustrate an example of the configuration of a message between a CU and a DU in connection with an interface (for example, F1 interface) between the CU and DU, which is necessary to support a continuous inter-base station handover based on layer 1/layer 2 signaling in connection with a split gNB, which may be used in FIG. 9, and some information elements (IEs) included in the message. Message names and IE names included in [Table 11] and [Table 12] are examples, and may be used with different names having identical functions.

[Table 11] illustrates an example of the configuration of a UE context modification request message which may be used in step 392-a in FIG. 9. The UE context modification request message may include a message type IE used to identify the message type, a gNB-CU UE F1AP ID IE which is an identifier used to identify the UE in the CU (for example, gNB-CU) of the gNB that transmits the message, and a gNB-DU UE F1AP ID IE which is an identifier used to identify the UE in the DU (for example, gNB-DU) of the gNB that receives the message. The UE context modification request message may include an LTM information modify IE including information for supporting an inter-base station handover based on layer 1/layer 2 signaling. The LTM information modify IE may include an LTM indicator IE which may include an indicator indicating layer 1/layer 2 signaling-based handover-related information, and may include an LTM configuration TD IE including an identifier for layer 1/layer 2 signaling-based handover-related information. In addition, the LTM information modify IE may include a reference configuration IE including layer 1/layer 2 signaling-based handover-related reference information, and a channel state information (CSI) resource configuration IE including layer 1/layer 2 signaling-based handover-related CSI resource information which may be added or modified.

### [Table 11]

### G.1 UE Context Modification Request

This message is sent by the gNB-CU to provide UE Context information changes to the gNB-DU.

Direction: gNB-CU→gNB-DU

| | | | | | | |
|---|---|---|---|---|---|---|
| | | | IE type and | | | Assigned |
| IE/Group Name | Presence | Range | reference | Semantics description | Criticality | Criticality |

| | | | | |
|---|---|---|---|---|
| Message Type | M | The Message Type IE | YES | reject |
| | | uniquely identifies the | | |
| | | message being sent. | | |
| gNB-CU UE F1AP | M | This IE uniquely identifies | YES | reject |
| ID | | the UE association | | |
| | | over the F1 interface | | |
| | | within the gNB-CU. | | |
| gNB-DU UE F1AP | M | This IE uniquely identifies | YES | reject |
| ID | | the UE association over | | |
| | | the F1 interface within | | |
| | | the gNB-DU. | | |

[ . . . ]

| | | | | | | |
|---|---|---|---|---|---|---|
| LTM Information | | 0 . . . 1 | | | YES | reject |
| Modify | | | | | | |
| >LTM Indicator | M | | ENUMERATED | | — | |
| | | | (true, . . . ) | | | |
| >LTM | M | | INTEGER | Corresponds to the LTM- | — | |
| Configuration | | | (1 . . . 8) | CandidateId IE, as defined | | |
| ID | | | | in TS 38.331 [8] | | |
| >Reference | O | | | This IE contains the | — | |
| Configuration | | | | reference configuration | | |
| | | | | used for LTM. | | |
| >CSI Resource | O | | OCTET | Includes the ltm-CSI- | — | |
| Configuration | | | STRING | ResourceConfigToAddModList | | |
| | | | | IE as defined in TS | | |
| | | | | 38.331 [8]. | | |
| LTM | O | | | This IE indicates the | YES | reject |
| Configuration ID | | | | list of LTM cells | | |
| Mapping List | | | | associated with its | | |
| | | | | configuration IDs. | | |

[ . . . ]

| | | | | | |
|---|---|---|---|---|---|
| AS Security | | 0 . . . 1 | | | reject |
| Context Info for | | | | | |
| Target Cell | | | | | |
| >Next Hop | O | | INTEGER | Next Hop Chaining Counter | |
| Chaining Count | | | (0 . . . 7) | (NCC) defined in TS 33.501. | |
| >Security Key | O | | INTEGER | | |
| Count | | | (0 . . . 65535) | | |

In addition, the UE context modification request message may include an LTM configuration ID mapping list IE including information of the list of information of cells to which a layer 1/layer 2 signaling-based handover is to be performed, which is associated with LTM configuration ID information. The UE context modification request message may additionally include an AS security context info for target cell IE for supporting a layer 1/layer 2 signaling-based handover. The AS security context info for target cell IE may include a next hop chaining count IE including an NCC value associated with an AS security key to be used in the target cell/target gNB to which a continuous handover based on layer 1/layer 2 signaling is to be performed by the UE, and may also include a security key count IE in case of using a method of generating a security key based on a key count. The UE may generate the AS security key to be used in the target cell/target gNB by using the NCC value included in the next hop chaining count IE, or the security count value included in the security key count IE.

[Table 12] illustrates an example of the configuration of a DU-CU cell switch notification message which may be used in step 421-a in FIG. 9. The DU-CU cell switch notification message may include a message type IE used to identify the message type, a gNB-CU UE F1AP ID IE which is an identifier used to identify the UE in the CU (for example, gNB-CU) of the gNB that receives the message, and a gNB-DU UE F1AP ID IE which is an identifier used to identify the UE in the DU (for example, gNB-DU) of the gNB that transmits the message. The DU-CU cell switch notification message may include a cell ID IE including target cell information, and an LTM cell switch information IE. The LTM cell switch information IE may include a TCI state ID IE including beam-related information by which the UE performs a layer 1/layer 2 signaling-based handover. The DU-CU cell switch notification message may additionally include an AS security context info for target cell IE for supporting a layer 1/layer 2 signaling-based handover. The AS security context info for target cell IE may include a next hop chaining count IE including an NCC value associated with the AS security key to be used in the target cell/target gNB to which a continuous handover based on layer 1/layer 2 signaling is to be performed by the UE, and may also include a security key count IE in case of using a method of generating a security key based on a key count. The UE may generate the AS security key to be used in the target cell/target gNB by using the NCC value included in the next hop chaining count IE, or the security count value included in the security key count IE.

### [Table 12]

### G.2 DU-CU Cell Switch Notification

This message is sent by the gNB-DU to inform the gNB-CU about the initiation of the cell switch command to the UE.

Direction: gNB-DU→gNB-CU

| | | | IE type and | Semantics | | Assigned |
|---|---|---|---|---|---|---|
| IE/Group Name | Presence | Range | reference | description | Criticality | Criticality |
| Message Type | M | | | The Message | YES | ignore |
| | | | | Type IE | | |
| | | | | uniquely | | |
| | | | | identifies the | | |
| | | | | message being | | |
| | | | | sent. | | |
| gNB-CU UE F1AP | M | | | This IE | YES | reject |
| ID | | | | uniquely | | |
| | | | | identifies the | | |
| | | | | UE association | | |
| | | | | over the F1 | | |
| | | | | interface | | |
| | | | | within the | | |
| | | | | gNB-CU. | | |
| gNB-DU UE F1AP | M | | | This IE | YES | reject |
| ID | | | | uniquely | | |
| | | | | identifies the | | |
| | | | | UE association | | |
| | | | | over the F1 | | |
| | | | | interface | | |
| | | | | within the | | |
| | | | | gNB-DU. | | |
| Cell ID | M | | NR CGI | | YES | reject |
| LTM Cell Switch | | 0 . . . 1 | | | YES | ignore |
| Information | | | | | | |
| >TCI State ID | M | | INTEGER | Corresponds to | — | |
| | | | (0 . . . 127) | the CandidateTCI- | | |
| | | | | StatesId IE as | | |
| | | | | defined in TS | | |
| | | | | 38.331. | | |
| AS Security | | 0 . . . 1 | | | | reject |
| Context Info for | | | | | | |
| Target Cell | | | | | | |
| >Next Hop | O | | INTEGER | Next Hop | | |
| Chaining Count | | | (0 . . . 7) | Chaining | | |
| | | | | Counter | | |
| | | | | (NCC) defined | | |
| | | | | in TS 33.501. | | |
| >Security Key | O | | INTEGER | | | |
| Count | | | (0 . . . 65535) | | | |

[Table 13] illustrates an example of the configuration of an LTM cell switch command MAC CE which is a MAC control element (CE) to be used by a base station to instruct a UE to perform a layer 1/layer 2 signaling-based handover, which may be used in steps 330, 430, and 530 in FIG. 7, FIG. 9, FIG. 11A to FIG. 11C, and FIG. 13A to FIG. 13C. Message names and element names included in [Table 13] are examples, and may be used with different names having identical functions.

In [Table 13], the “R” fields in Octet 1 denote “reserved” bits and are configured to be 0. The “Target Config ID” field may include configuration information applied to the target cell, to which the UE is to perform a layer 1/layer 2 signaling-based handover.

The “TCI state ID” field indicates beam-related information in the target cell when the UE performs a layer 1/layer 2 signaling-based handover. The “UL TCI state ID” field indicates uplink beam-related information and activation in the target cell when performing a layer 1/layer 2 signaling-based handover. The “timing advance command” field may include valid timing advance (TA) information in the target cell when the UE performs a layer 1/layer 2 signaling-based handover.

### [Table 13]

### H.1 LTM Cell Switch Command MAC CE

| | | | | | | |
|---|---|---|---|---|---|---|
| R | SK | NCC | C | S/U | Target Config ID | Oct 1 |

| | | | | | |
|---|---|---|---|---|---|
| R | R | R | R | Timing Advance Command | Oct 2 |

| Timing Advance Command | | Oct 3 |
|---|---|---|
| R | TCI state ID | Oct 4 |

| UL TCI state ID | | Oct 5 |
|---|---|---|
| Random Access Preamble index | SS/PBCH index | Oct 6 |

| | | |
|---|---|---|
| SS/PBCH index | PRACH Mask index | Oct 7 |

| | |
|---|---|
| Next Hop Chaining Count | Oct 8 |
| Security Key Count | Oct 9 |
| Security Key Count | Oct 10 |

The “C” field indicates whether fields related to contention-free random access resources are included or not. In case that the “C” field is configured to be 1, a “random access preamble index” field is included. The “random access preamble index” field indicates preamble index information needed by the UE to perform a contention-free random access. The “S/U” field indicates the type of the uplink carrier for performing a contention-free random access. The “S/U” field, if configured to be 1, indicates a supplementary uplink (SUL) and, if configured to be 0, indicates a normal uplink (NUL). The “SS/PBCH index” field and “PRACH mask index” field include information used by the UE to determine a RACH occasion in order to perform a contention-free random access.

The LTM cell switch command MAC CE may additionally include security-related information which is necessary when performing a layer 1/layer 2 signaling-based handover. The “NCC” field indicates whether a “next hop chaining count” field is included or not. The “NCC” field, if configured to be 1, indicates that the “next hop chaining count” field is included. The “next hop chaining count” field includes an NCC value associated with an AS security key which is necessary to generate an AS security key after the UE performs a layer 1/layer 2 signaling-based handover. The “SK” field indicates whether a “security key count” field is included or not. The “SK” field, if configured to be 1, indicates that the “security key count” field is included. The “security key count” field may include a security key count value for generating an AS security key after the UE performs a layer 1/layer 2 signaling-based handover.

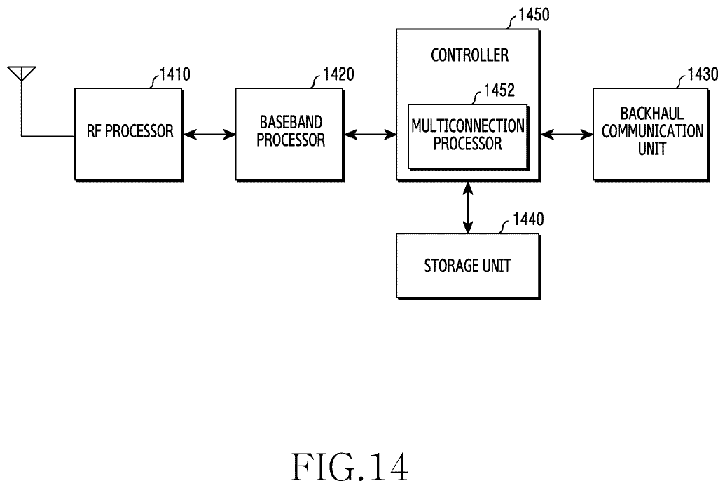

FIG. 14 illustrates a structure of an RAN node according to an embodiment of the disclosure. Referring to FIG. 14, the RAN node may include an RF processor 1410, a baseband processor 1420, a backhaul communication unit 1430, a storage unit 1440, and a controller 1450. If the RAN node is divided into a central unit (CU) and a distributed unit (DU), then the block diagram may have a different structure from that included in FIG. 14. As an example, the RF processor 1410 and the baseband processor 1420 may be included in the DU, together with the controller, the storage unit, and the backhaul communication unit for communication with the CU, and as an example, the backhaul communication unit 1430 may be included in the CU, together with the controller, the storage unit, and the backhaul communication unit for communication with the DU.

The RF processor 1410 may perform functions for transmitting/receiving signals through a radio channel, such as signal band conversion and amplification. The RF processor 1410 may up-convert a baseband signal provided from the baseband processor 1420 to an RF band signal, may transmit the same through an antenna, and may down-convert an RF band signal received through the antenna to a baseband signal. For example, the RF processor 1410 may include a transmission filter, a reception filter, an amplifier, a mixer, an oscillator, a DAC, and an ADC. Although only one antenna is illustrated in the drawing, the first access node may include multiple antennas. In addition, the RF processor 1410 may include multiple RF chains. Furthermore, the RF processor 1410 may perform beamforming. For the beamforming, the RF processor 1410 may adjust the phase and magnitude of signals transmitted/received through multiple antennas or antenna elements, respectively. The RF processor may transmit one or more layers to perform a downward MIMO operation.

The baseband processor 1420 may perform functions of conversion between baseband signals and bitstrings according to the physical layer specifications of first radio access technology. For example, during data transmission, the baseband processor 1420 may encode and modulate a transmitted bitstring to generate complex symbols. In addition, during data reception, the baseband processor 1420 may demodulate and decode a baseband signal provided from the RF processor 1410 to restore a received bitstring. For example, when following the OFDM scheme, during data transmission, the baseband processor 1420 may encode and modulate a transmitted bitstring to generate complex symbols, may map the complex symbols to subcarriers, and may configure OFDM symbols through IFFT operation and CP insertion. In addition, during data reception, the baseband processor 1420 may split a baseband signal provided from the RF processor 1410 at the OFDM symbol level, may restore signals mapped to subcarriers through FFT operation, and may restore a received bitstring through demodulation and decoding. The baseband processor 1420 and the RF processor 1410 transmit and receive signals as described above. Therefore, the baseband processor 1420 and the RF processor 1410 may be referred to as a transmitter, a receiver, a transceiver, or a communication unit.

The backhaul communication unit 1430 provides an interface for communicating with other nodes in the network. The backhaul communication unit 1430 may convert bitstrings transmitted from the main RAN node to other nodes (for example, auxiliary base station and core network) to physical signals, and may convert physical signals received from the other nodes to bitstrings.

The storage unit 1440 may store data such as basic programs, application programs, and configuration information for operations of the main RAN node. Particularly, the storage unit 1440 may store information regarding a bearer allocated to a connected UE, a measurement result reported from the connected UE, and the like. In addition, the storage unit 1440 may store information serving as a reference to determine whether to provide multi-connection to a UE or to suspend the same. In addition, the storage unit 1440 may provide the stored data at the request of the controller 1450.

The controller 1450 may control the overall operation of the main RAN node. For example, the controller 1450 transmits/receives signals through the baseband processor 1420 and the RF processor 1410 or through the backhaul communication unit 1430. In addition, the controller 1450 records data in the storage unit 1440 and reads the data from the storage unit 1440. To this end, the controller 1450 may include at least one processor. Also, the controller 1450 may be used to control the overall operation of an NCR.

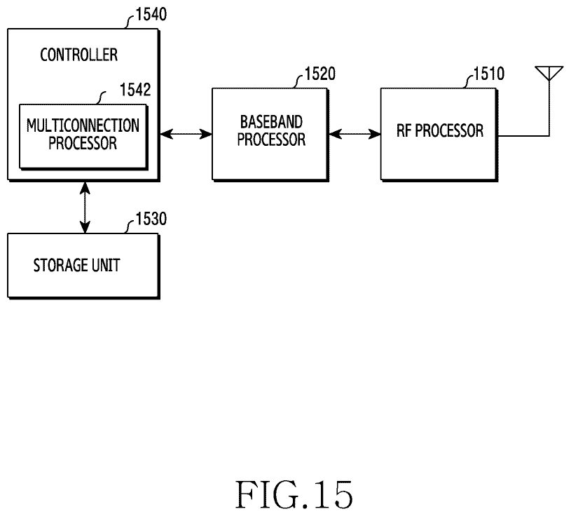

FIG. 15 illustrates a structure of a UE according to an embodiment of the disclosure. Referring to FIG. 15, the UE may include a radio frequency (RF) processor 1510, a baseband processor 1520, a storage unit 1530, and a controller 1540. The RF processor 1510 may perform functions for transmitting/receiving signals through a radio channel, such as signal band conversion and amplification. That is, the RF processor 1510 may up-convert a baseband signal provided from the baseband processor 1520 to an RF band signal, may transmit the same through an antenna, and may down-convert an RF band signal received through the antenna to a baseband signal. For example, the RF processor 1510 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1510 may include multiple RF chains. Furthermore, the RF processor 1510 may perform beamforming. For the beamforming, the RF processor 1510 may adjust the phase and magnitude of signals transmitted/received through multiple antennas or antenna elements, respectively. In addition, the RF processor may perform MIMO, and may receive multiple layers when performing a MIMO operation.

The baseband processor 1520 may perform functions of conversion between baseband signals and bitstrings according to the system's physical layer specifications. For example, during data transmission, the baseband processor 1520 may encode and modulate a transmitted bitstring to generate complex symbols. In addition, during data reception, the baseband processor 1520 may demodulate and decode a baseband signal provided from the RF processor 1510 to restore a received bitstring. For example, when following the orthogonal frequency division multiplexing (OFDM) scheme, during data transmission, the baseband processor 1520 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1520 may split a baseband signal provided from the RF processor 1510 at the OFDM symbol level, may restore signals mapped to subcarriers through a fast Fourier transform (FFT) operation, and may restore a received bitstring through demodulation and decoding.

The baseband processor 1520 and the RF processor 1510 may transmit and receive signals as described above. Therefore, the baseband processor 1520 and the RF processor 1510 may be referred to as a transmitter, a receiver, a transceiver, or a communication unit. Furthermore, at least one of the baseband processor 1520 and the RF processor 1510 may include multiple communication modules to support multiple different radio access technologies. In addition, at least one of the baseband processor 1520 and the RF processor 1510 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

The storage unit 1530 stores data such as basic programs, application programs, and configuration information for operations of the NCR. In addition, the storage unit 1530 may provide the stored data at the request of the controller 1540.

The controller 154 may control the overall operation of an NCR. For example, the controller 1540 may transmit/receive signals through the baseband processor 1520 and the RF processor 1510. In addition, the controller 1540 records data in the storage unit 1530 and reads the data from the storage unit 1530. To this end, the controller 1540 may include at least one processor. For example, the controller 1540 may include a communication processor (CP) configured to perform control for communication, and an application processor (AP) configured to control upper layers such as application programs.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. As an example, the methods provided in the disclosure may be partially combined with each other to operate a base station and a terminal. Moreover, although the above embodiments have been described based on the 5G or NR system, other variants based on the technical idea of the embodiments may also be implemented in other communication systems such as LTE, LTE-A, or LTE-A-Pro systems.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first base station (BS) which is an anchor BS for a lower layer triggered mobility (LTM) in a wireless communication system, the method comprising:
transmitting, to a second BS which is a candidate BS for the LTM, a handover message;
receiving, from the second BS, a handover acknowledgement message;
identifying an LTM cell switch to the second BS among at least one candidate BS;
transmitting, to a user equipment (UE), a medium access control (MAC) control element (CE) including an LTM cell switch command, wherein the MAC CE includes information on a next hop chain count (NCC) associated with a security key for the second BS; and
transmitting, to the second BS, a cell switch notification message.

2. The method of claim 1, wherein the handover message includes a list of UE reference identity (ID) and information on the at least one candidate BS,
wherein the list of UE reference ID includes a UE reference ID for the at least one candidate BS at an Xn interface, and
wherein the handover message further includes a list of information for data forwarding to the at least one candidate BS.

3. The method of claim 1, further comprising:
receiving, from the second BS, a handover success message, in case that the UE is connected to the second BS; and
forwarding, to the second BS, user data of the UE based on the information for the at least one candidate BS.

4. The method of claim 1, further comprising:
generating an LTM configuration based on the handover acknowledgement message; and
transmitting, to the UE, a radio resource control (RRC) connection reconfiguration message including the LTM configuration.

5. The method of claim 1, wherein the cell switch notification message includes information on the NCC associated with the security key for the second BS.

6. The method of claim 1, wherein the security key for the second BS is generated based on a previous security key.

7. A method performed by a second base station (BS) which is a candidate BS for a lower layer triggered mobility (LTM) in a wireless communication system, the method comprising:
receiving, from a first BS which is an anchor BS for the LTM, a handover message;
transmitting, to the first BS, a handover acknowledgement message; and
receiving, from the first BS, a first cell switch notification message.

8. The method of claim 7, wherein the handover message includes a list of UE reference ID and information on the at least one candidate BS,
wherein the list of UE reference ID includes a UE reference ID for the at least one candidate BS at an Xn interface, and
wherein the handover message further includes a list of information for data forwarding to the at least one candidate BS.

9. The method of claim 7, further comprising:
transmitting, to the first BS, a handover success message, in case that the UE is connected to the second BS,
wherein user data of the UE is forwarded from the second BS based on information for the at least one candidate BS.

10. The method of claim 7, further comprising:
identifying an LTM cell switch to a third BS among the at least one candidate BS;
transmitting, to the UE, medium access control (MAC) control element (CE) including an LTM cell switch command, wherein the MAC CE includes information on a next hop chain count (NCC) associated with a security key for the third BS; and
transmitting, to the third BS, a second cell switch notification message.

11. The method of claim 10, wherein the first cell switch notification message includes information on the NCC associated with a security key for the second BS, and
wherein the second cell switch notification message includes information on the NCC associated with the security key for the third BS.

12. The method of claim 7, wherein a security key for the second BS is generated based on a previous security key.

13. A first base station (BS) which is an anchor BS for a lower layer triggered mobility (LTM) in a wireless communication system, the first BS comprising:
a transceiver; and
a controller coupled with the transceiver and configured to:
transmit, to a second BS which is a candidate BS for the LTM, a handover message,
receive, from the second BS, a handover acknowledgement message,
identify an LTM cell switch to the second BS among at least one candidate BS,
transmit, to a user equipment (UE), medium access control (MAC) control element (CE) including an LTM cell switch command, wherein the MAC CE includes information on a next hop chain count (NCC) associated with a security key for the second BS, and
transmit, to the second BS, a cell switch notification message.

14. The first BS of claim 13, wherein the handover message includes a list of UE reference identity (ID) and information on the at least one candidate BS,
wherein the list of UE reference ID includes UE reference ID for the at least one candidate BS at an Xn interface, and
wherein the handover message further includes a list of information for data forwarding to the at least one candidate BS.

15. The first BS of claim 13, wherein the controller is further configured to:
receive, from the second BS, a handover success message, in case that the UE is connected to the second BS, and
forward, to the second BS, user data of the UE based on the information for the at least one candidate BS.

16. The first BS of claim 13, wherein the controller is further configured to:
generate an LTM configuration based on the handover acknowledgement message; and
transmit, to the UE, a radio resource control (RRC) connection reconfiguration message including the LTM configuration.

17. The first BS of claim 16, wherein the cell switch notification message includes information on the NCC associated with a security key for the second BS.

18. The first BS of claim 13, wherein the security key for the second BS is generated based on a previous security key.

19. A second base station (BS) capable of a candidate BS for a lower layer triggered mobility (LTM) in a wireless communication system, the second BS comprising:
a transceiver; and
a controller coupled with the transceiver and configured to:
receive, from a first BS capable of an anchor BS for the LTM, a handover message,
transmit, to the first BS, a handover acknowledgement message, and
receive, from the first BS, a first cell switch notification message.

20. The second BS of claim 19, wherein the controller is further configured to:
identify an LTM cell switch to a third BS among the at least one candidate BS,
transmit, to the UE, medium access control (MAC) control element (CE) including an LTM cell switch command, the MAC CE including information on a next hop chain count (NCC) associated with a security key for the second BS, and
transmit, to the third BS, a second cell switch notification message.
